(19) United States
(12) Patent Application Publication
(10) Pub. No.: US 2002/0023040 A1
(43) Pub. Date: Feb. 21, 2002

(54) Controlling a trading account owned by a securities trader

(76) Inventors: Thurston Gilman, Newton, MA (US); David Gelfond, Newtonville, MA (US); Scott Gilman, Cambridge, MA (US); Aleke Msumba, Grafton, MA (US); Paul Bonnarigo, Billerica, MA (US)

Correspondence Address: FRANK R. OCCHIUTI, Fish & Richardson P.C., 225 Franklin Street, Boston, MA, 02110-2804, US

(21) Appl. No.: 09/777,397

(22) Filed: Feb. 6, 2001

Related U.S. Application Data
(60) Provisional application No. 60/180,520, filed on Feb. 7, 2000.

(51) Int. Cl. G06F 17/60

(52) U.S. Cl. 705/37

(57) ABSTRACT

A computer network includes a first computer for use by a securities trader and a second computer for use by an account administrator. The account administrator controls a trading account owned by the securities trader from the second computer. The second computer executes instructions to perform functions including, but not limited to receiving, from the account administrator, information including a password and data identifying the trading account and the securities trader, providing the information to an authenticating server to obtain access to the trading account, and performing an action that relates to the trading account without requiring the consent of the securities trader to perform the action.

### CLAIM TO PRIORITY

This application claims priority from U.S. Provisional Application No. 60/180,520, filed on Feb. 7, 2000, the contents of which are hereby incorporated by reference into this application.

### BACKGROUND

This invention relates generally to controlling a trading account owned by a securities trader and, more particularly, to taking actions with respect to the account without requiring the consent of the trader.

Computerized trading of securities, such as stocks and bonds, has grown in popularity in recent years. The Internet, in particular, has had a profound impact on the ability of individuals to conduct their own securities trades. Generally speaking, in computerized trading systems, users, i.e., traders, sign onto a trading network, access their accounts, and execute trades directly from those accounts.

### SUMMARY

In general, in one aspect, the invention is directed to a controlling a trading account owned by a securities trader. This aspect of the invention features receiving information that includes a password and data identifying the trading account and the securities trader, obtaining access to the trading account based on the information, and performing an action that relates to the trading account without requiring the consent of the securities trader to perform the action. This aspect may also include one or more of the following features.

The action may include formulating a securities trade for the securities account, executing a trade from the securities account, viewing trades made by the securities trader from the securities account, and/or reporting trading activity from the trading account to a third party. If the trading account has open positions, the action may include updating the trading account. Updating the trading account, in this aspect, may include storing information relating to trading activity that occurred within a predetermined time period.

The action performed with respect to the trading account may include setting privileges available to the securities trader on the trading account, which privileges include defining operations that the trader can perform from the securities account. Defining the operations may include modifying existing privileges of the securities trader. If the securities trader has no previously-established privileges, defining the operations may include establishing privileges for the securities trader.

The action may include setting login criteria to the trading account for the securities trader, setting a buying limit for the securities trader on the trading account, setting broker commission payment amounts for the securities account, combining one or more trades made from the securities account into a single trade, and/or updating information in the trading account. The information in the trading account may include one or more of a user name, a password, a buying limit, a commission fee, an account number, an account type, and connections to servers for market makers.

The action may include viewing one or more messages sent from a server to the trading account, viewing one or more messages sent from the trading account to a server, viewing performance of a security in the trading account, and/or viewing a value of the trading account.

This summary has been provided so that the nature of the invention can be understood quickly. A detailed description of illustrative embodiments of the invention is set forth below.

### DESCRIPTION OF THE DRAWINGS

FIG. 1, comprised of FIGS. 1a and 1b, is a block diagram of a securities trading network.

FIG. 2 is a diagram showing the data flow on the securities trading network.

FIGS. 3 to 66 are screen shots of graphical user interfaces displayed by computer programs running on computers on the securities trading network.

FIG. 67 is a flowchart showing a process for controlling actions performed in a trading account.

Like reference numerals in the figures indicate like elements.

### DESCRIPTION

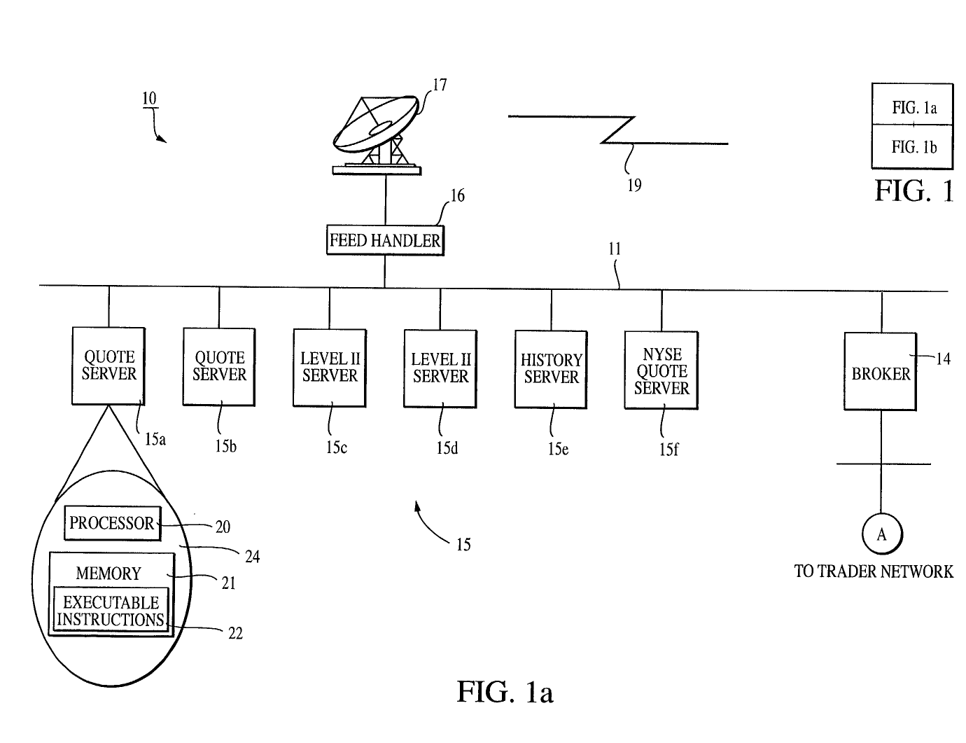

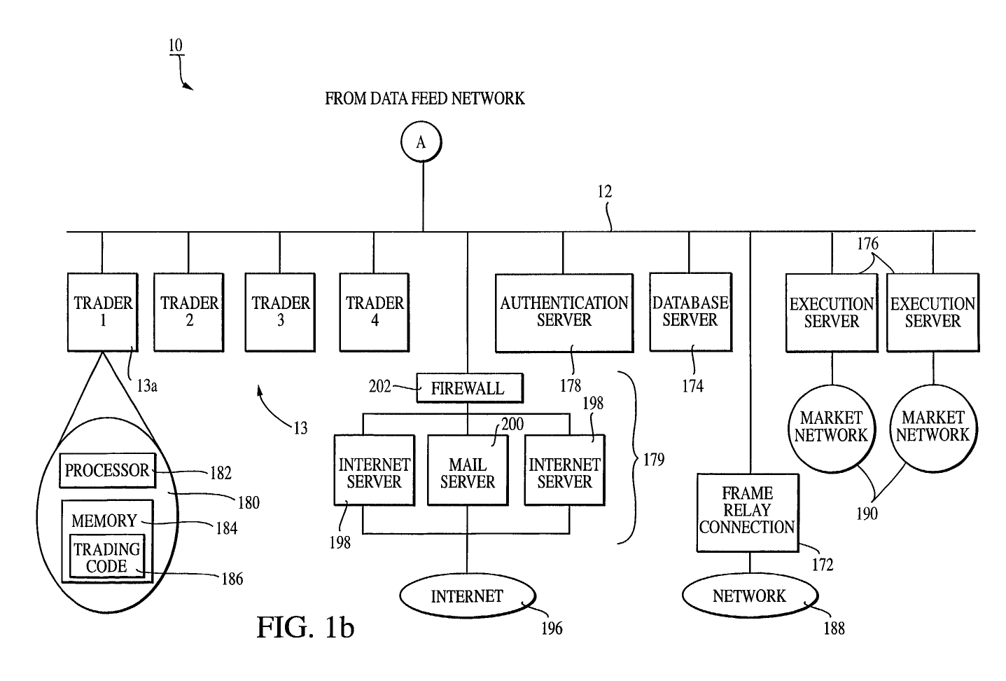

FIG. 1 shows a network 10. Conceptually, network 10 can be divided into trader network 12 (FIG. 1b) and data feed network 11 (FIG. 1a); although these two networks may be part of a single, larger network. Data feed network 11 receives and stores information using various servers. Traders access this information via trader network 12 and execute trades based on this information.

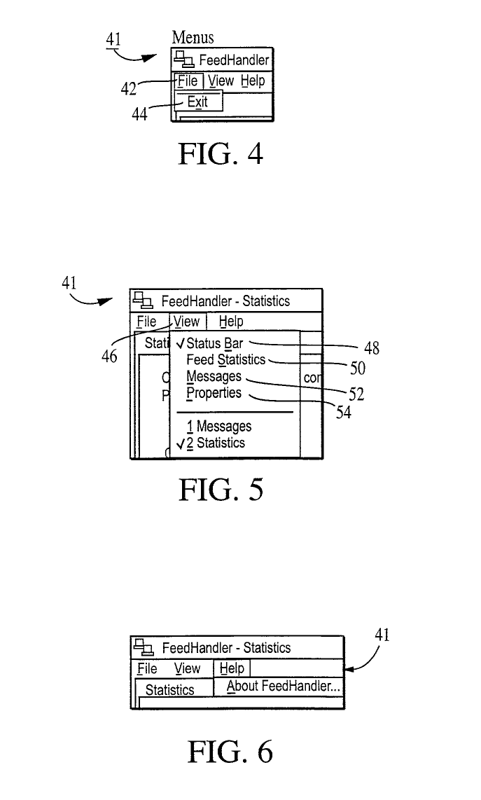

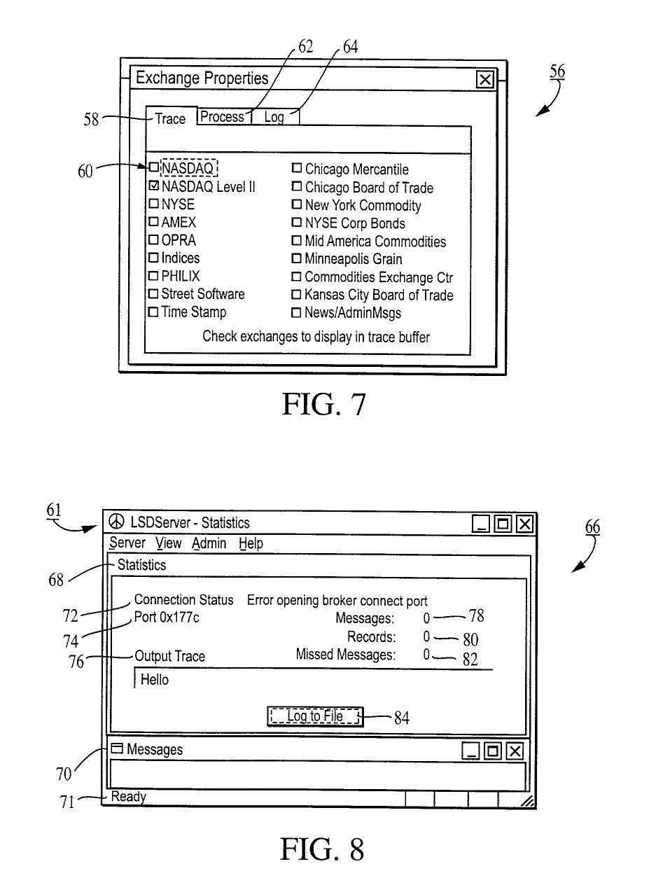

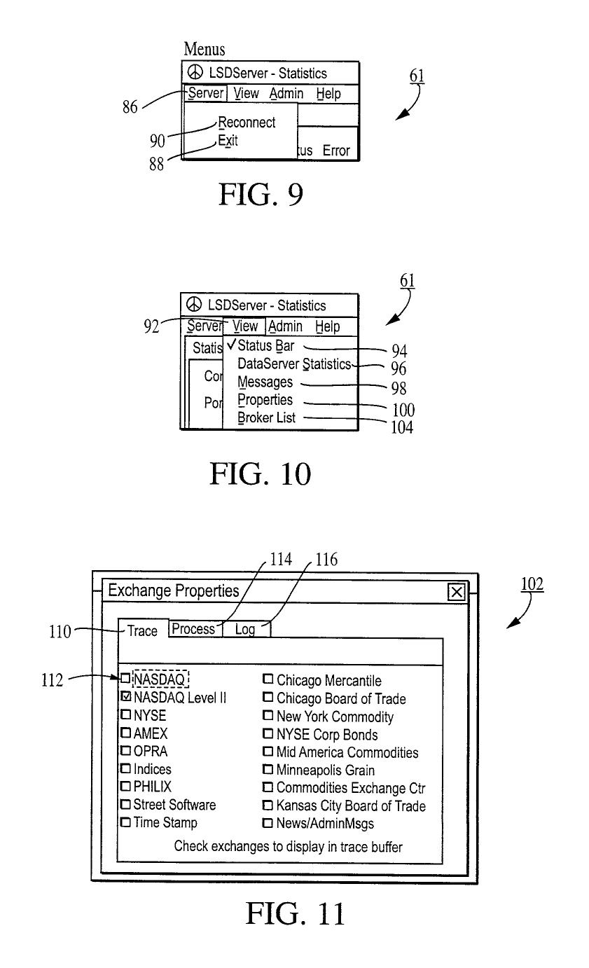

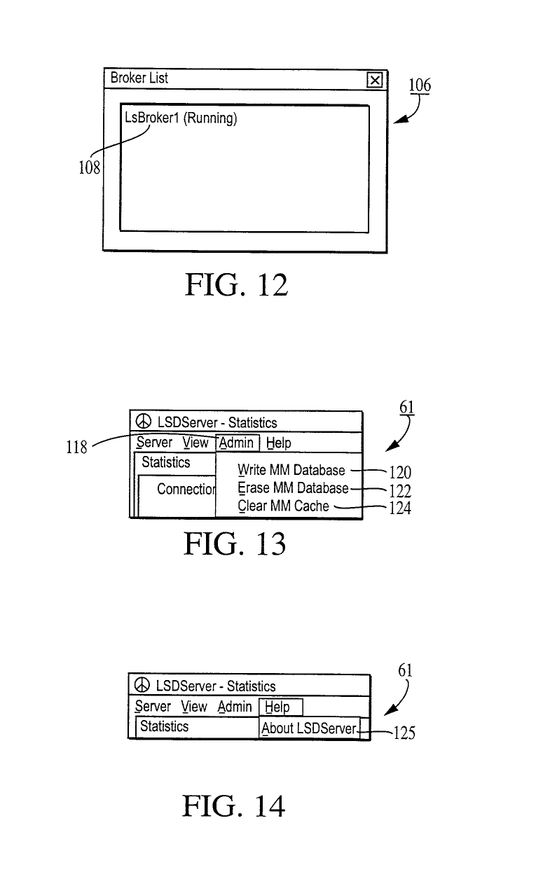

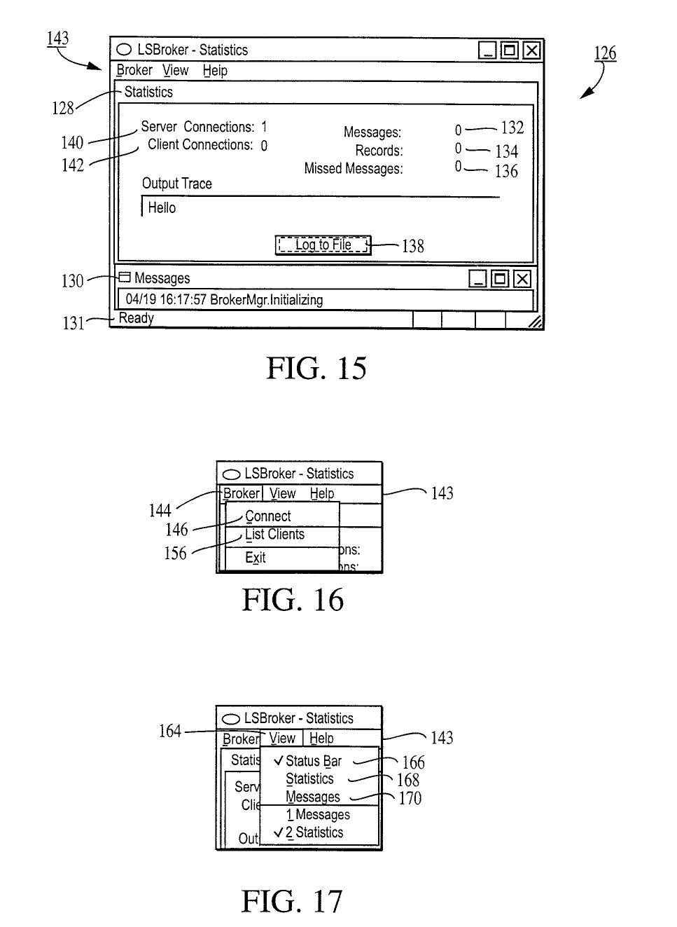

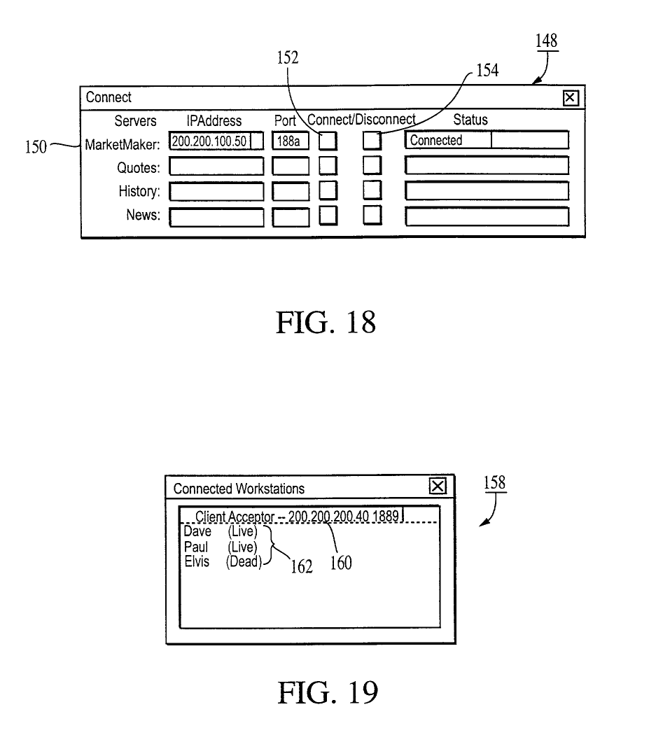

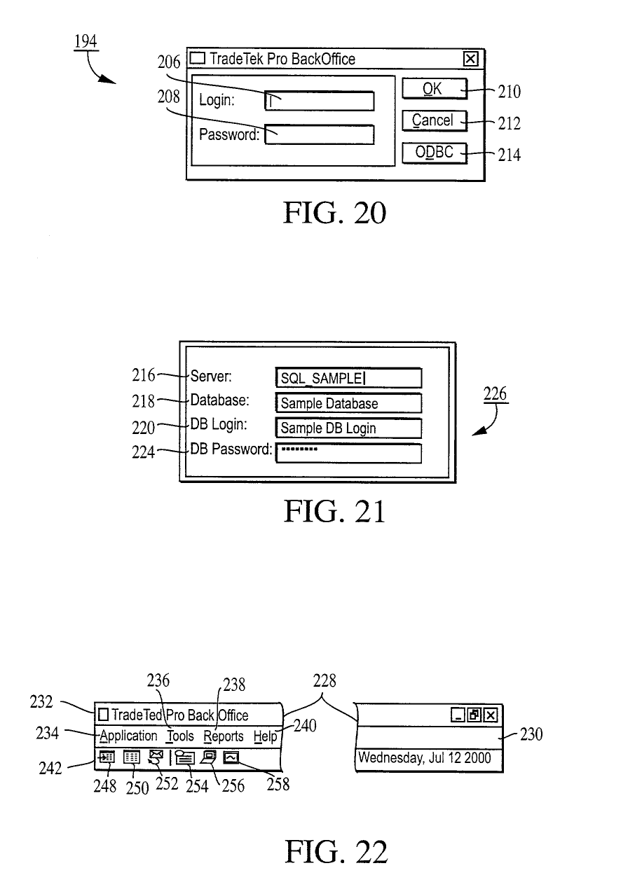

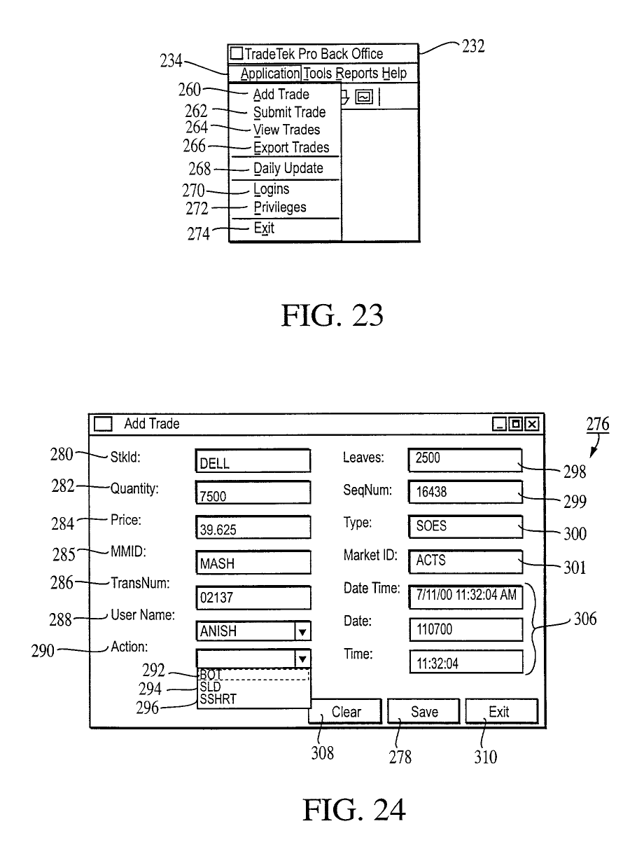

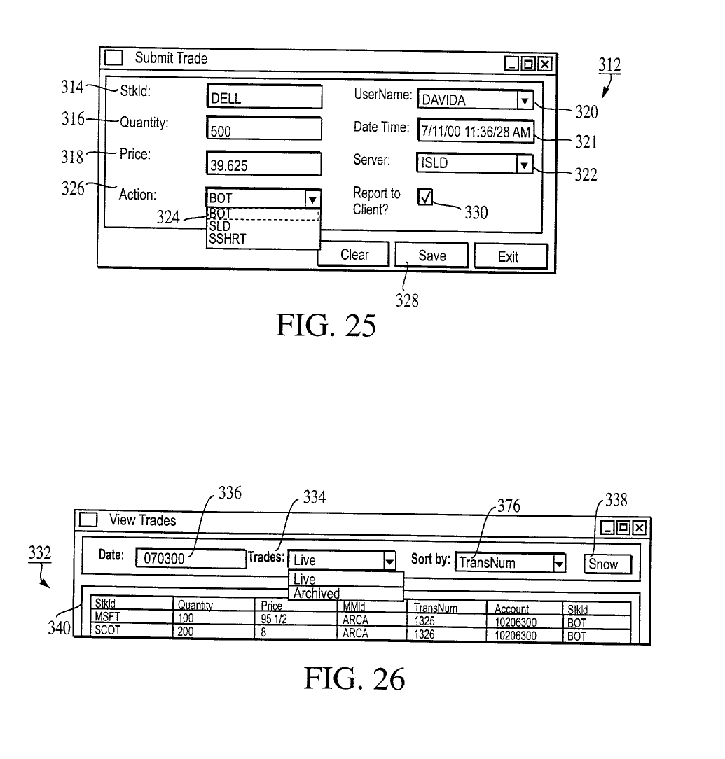

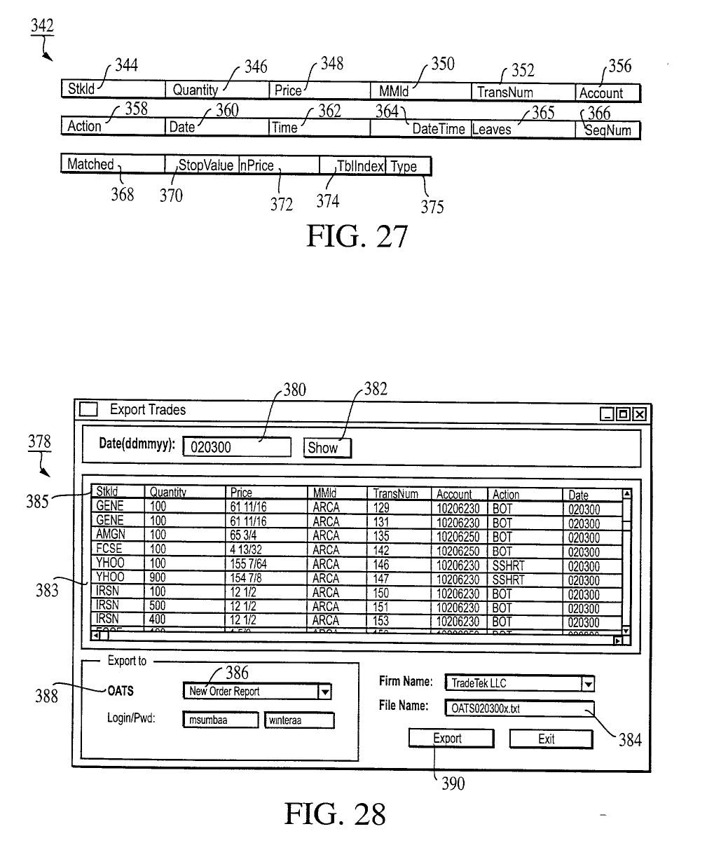

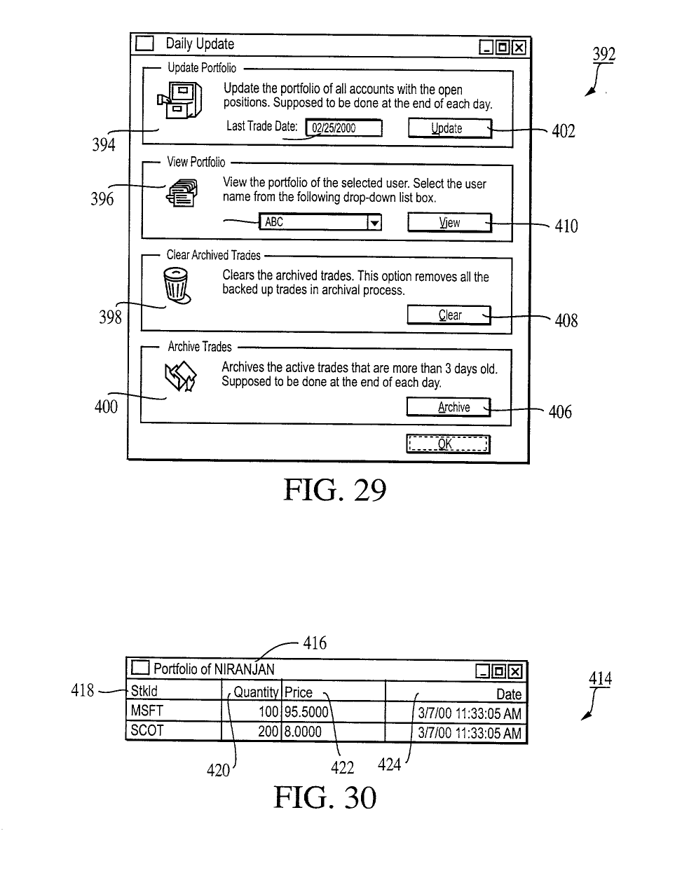

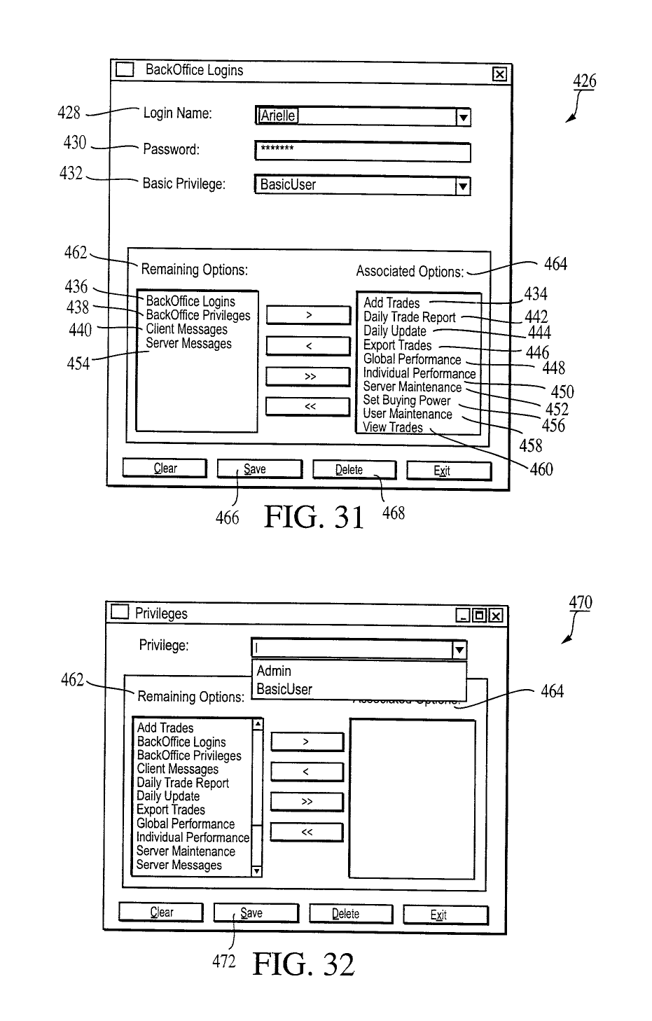

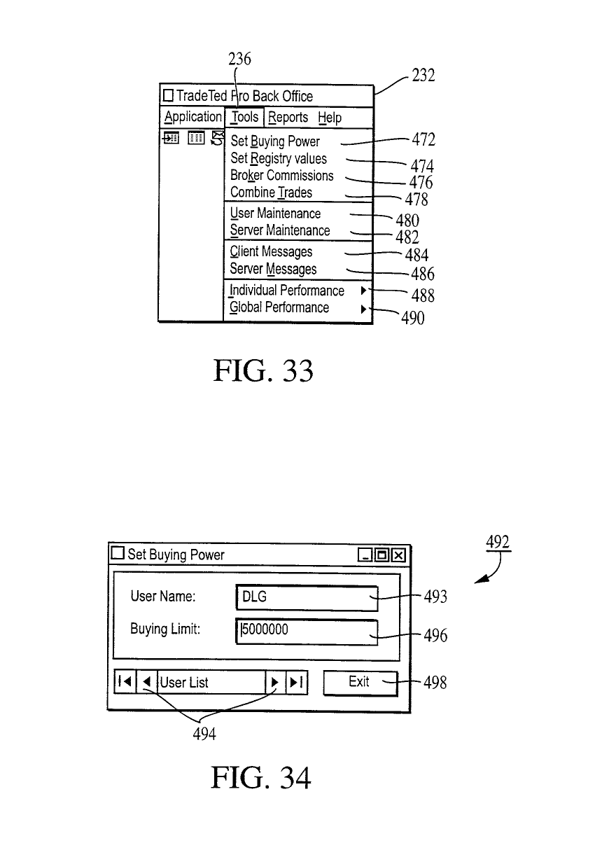

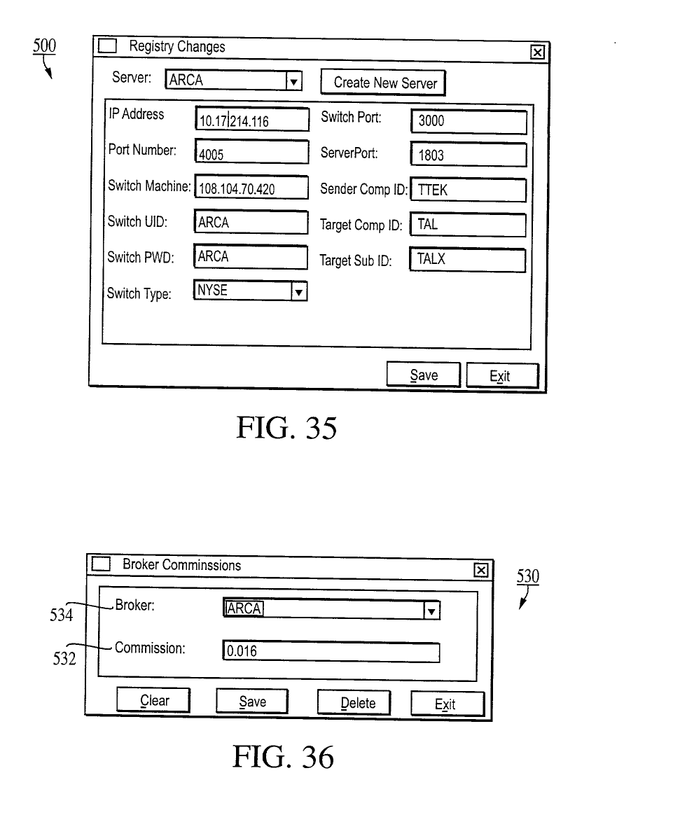

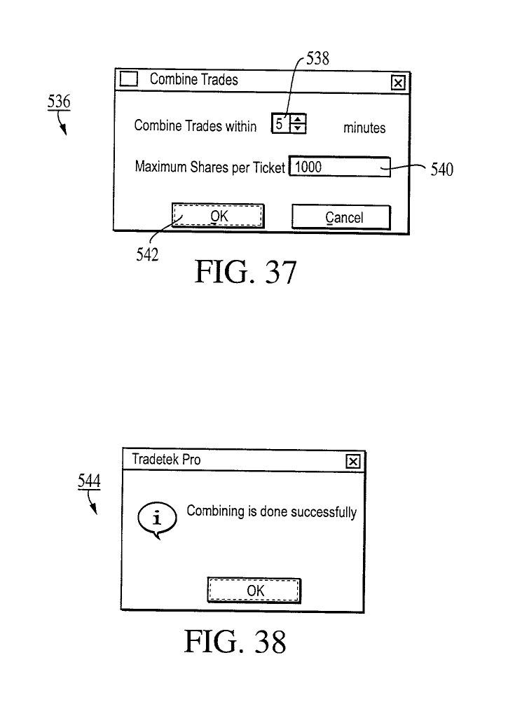

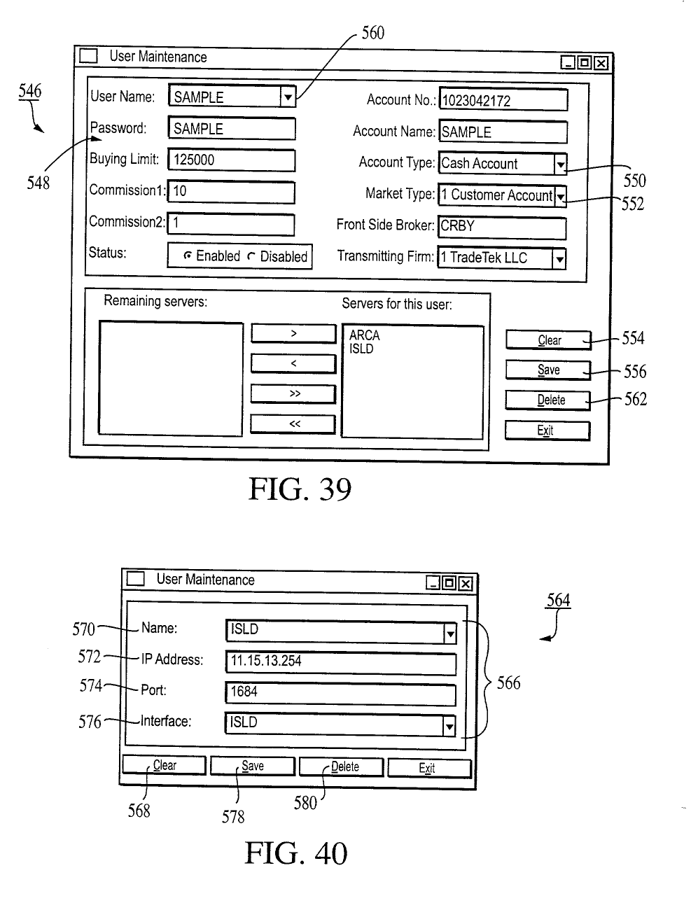

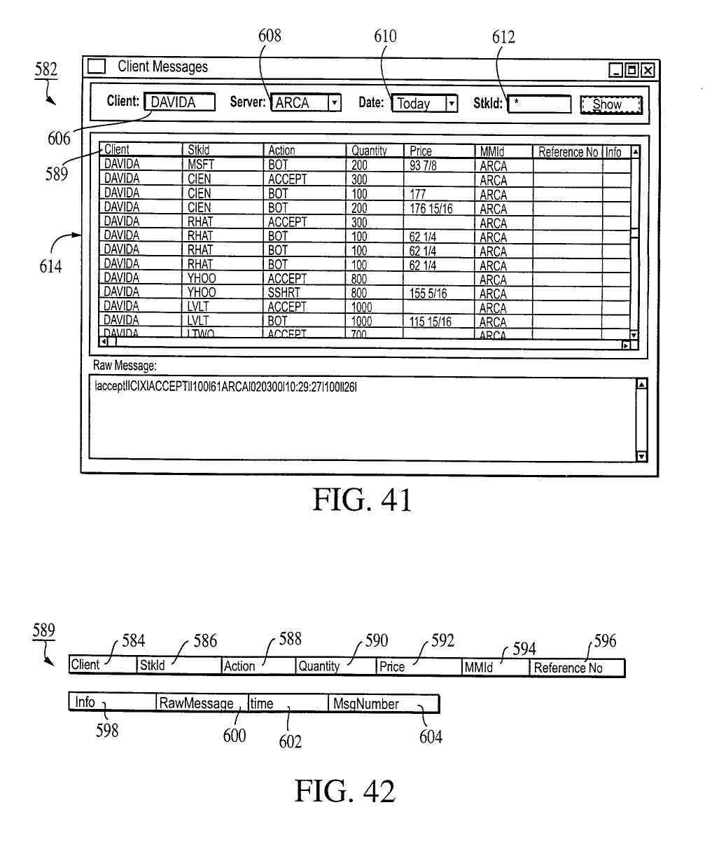

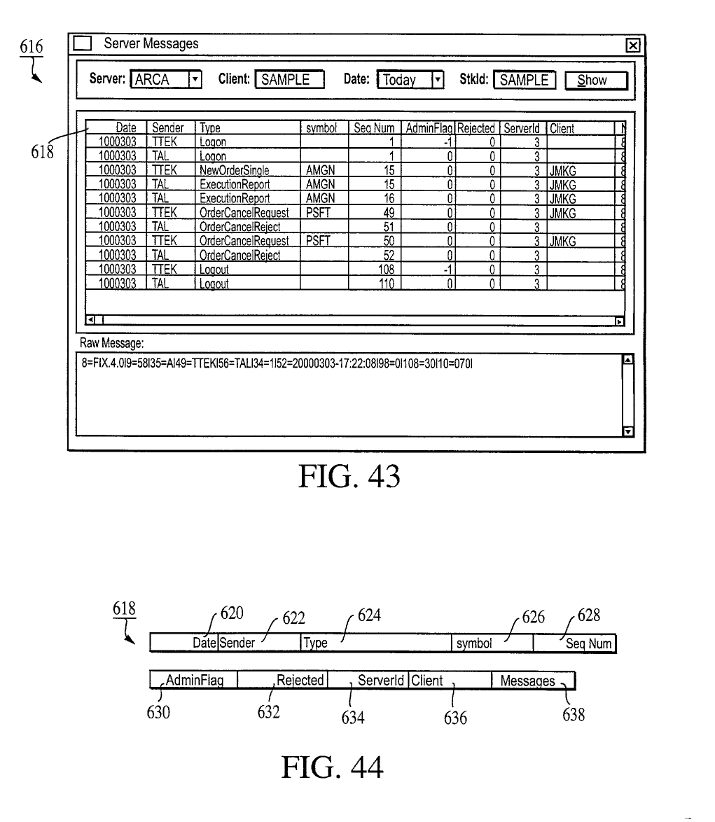

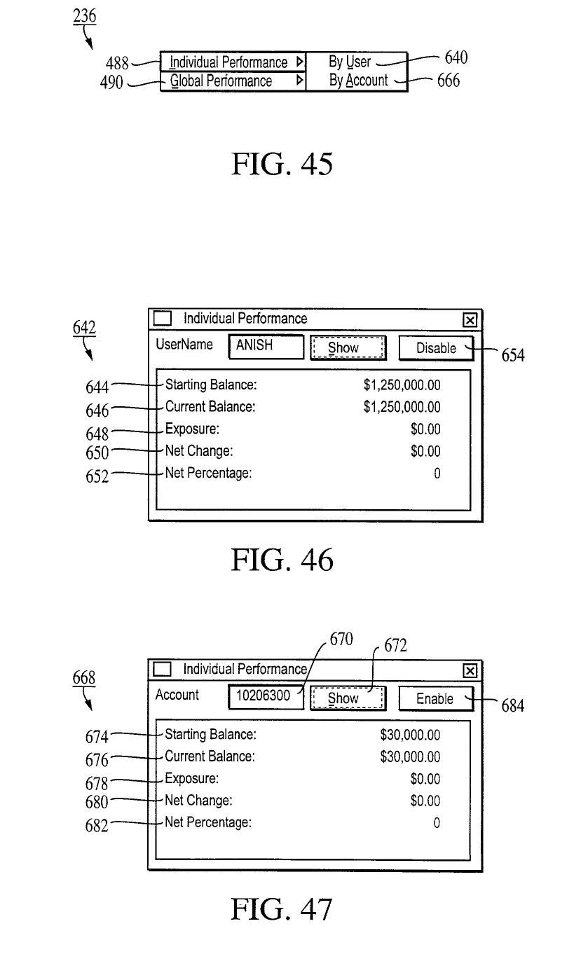

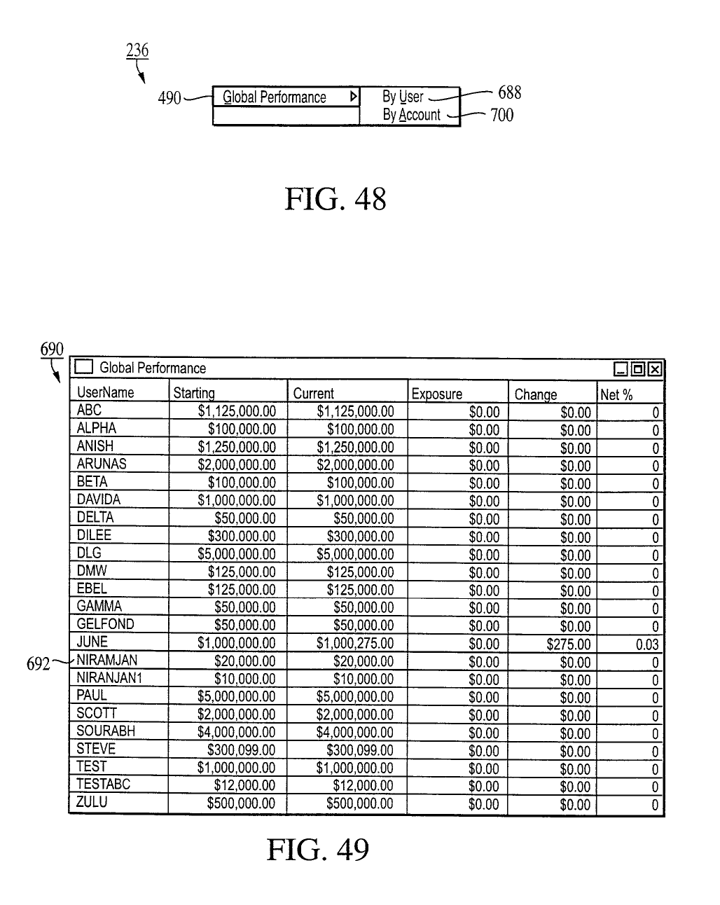

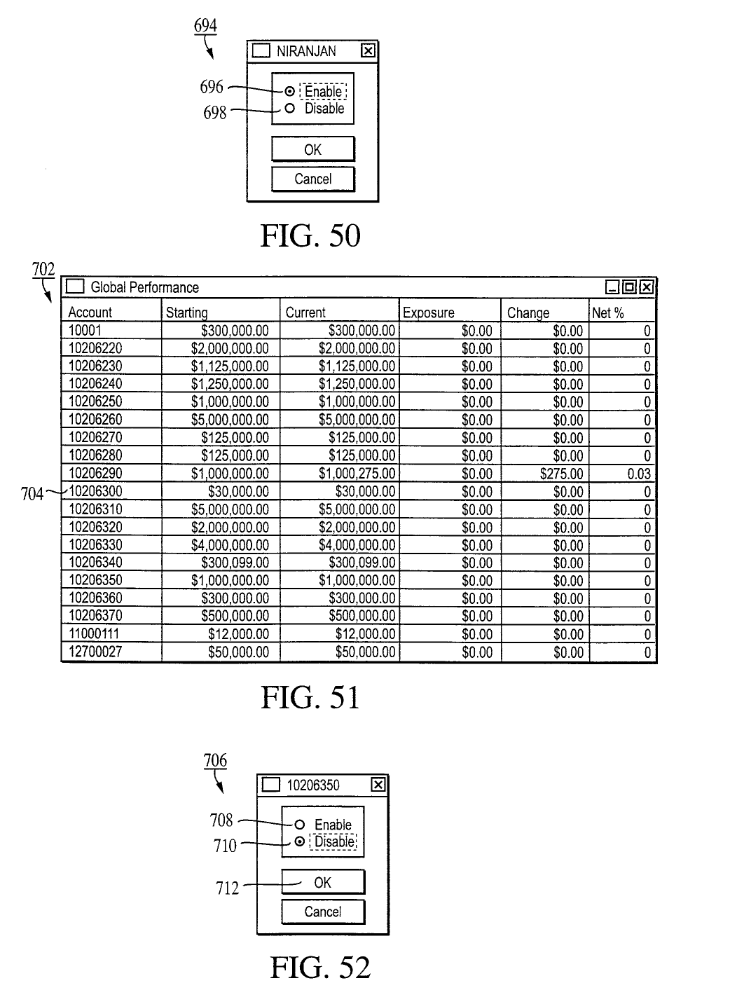

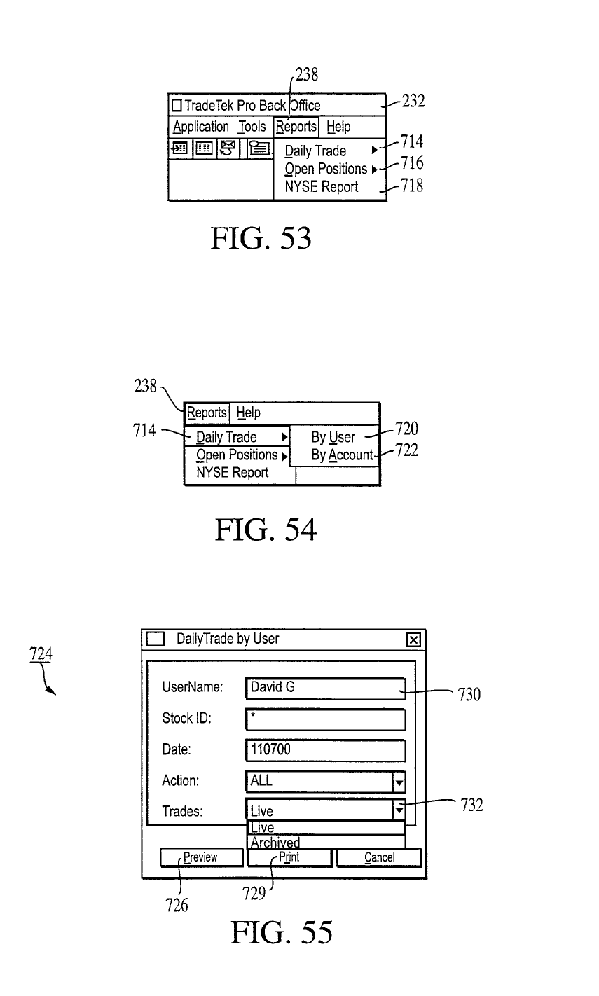

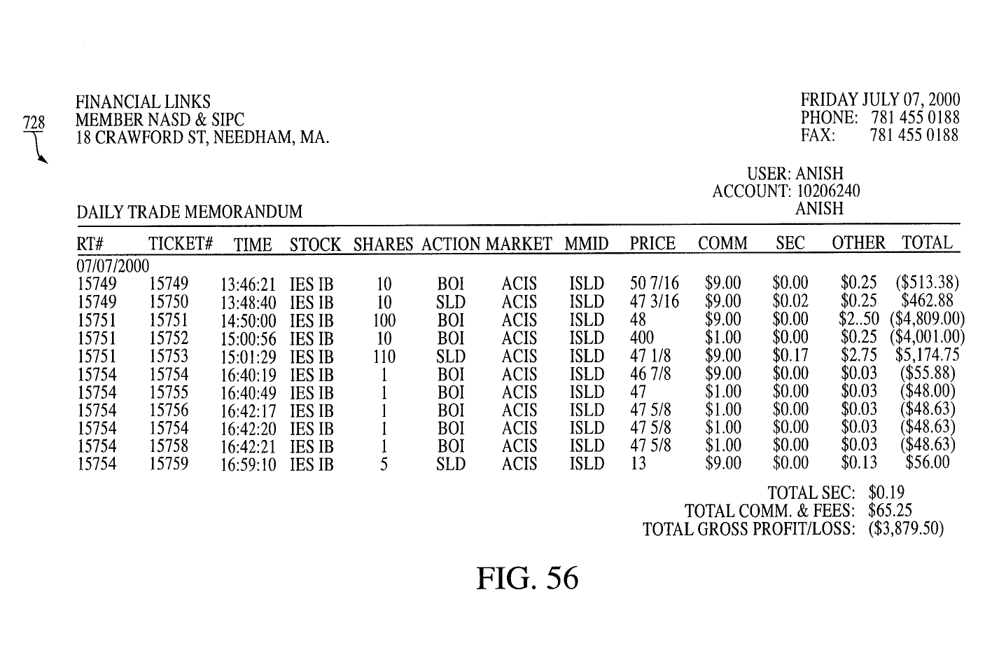

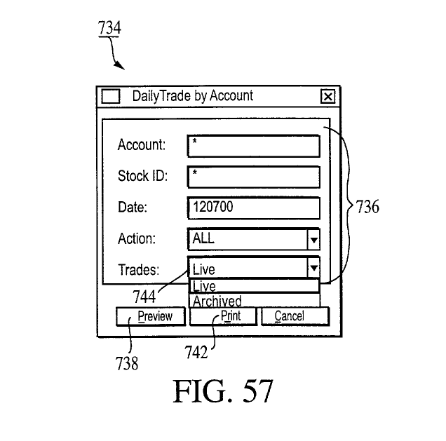

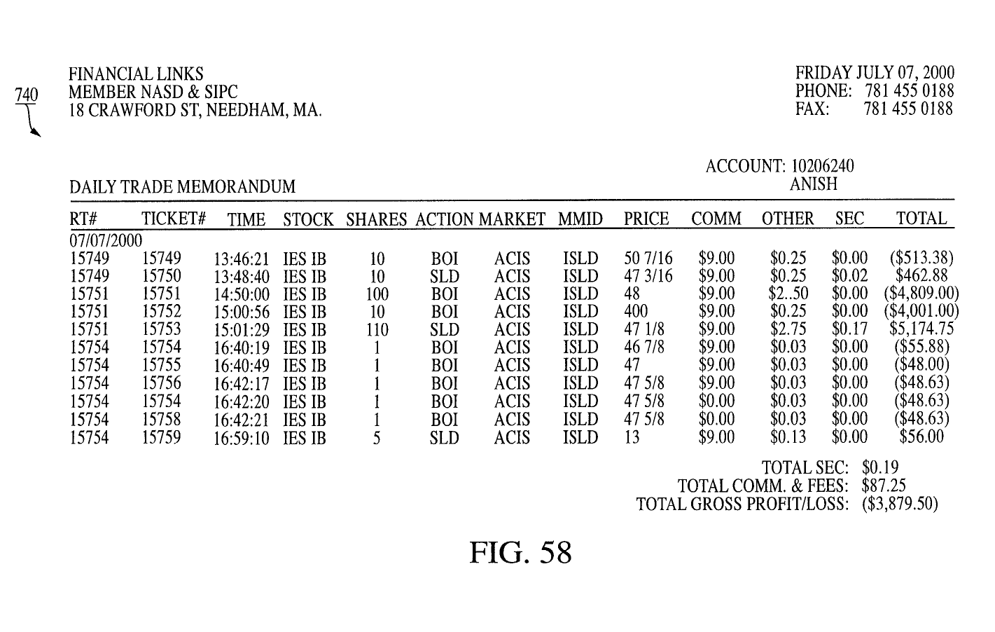

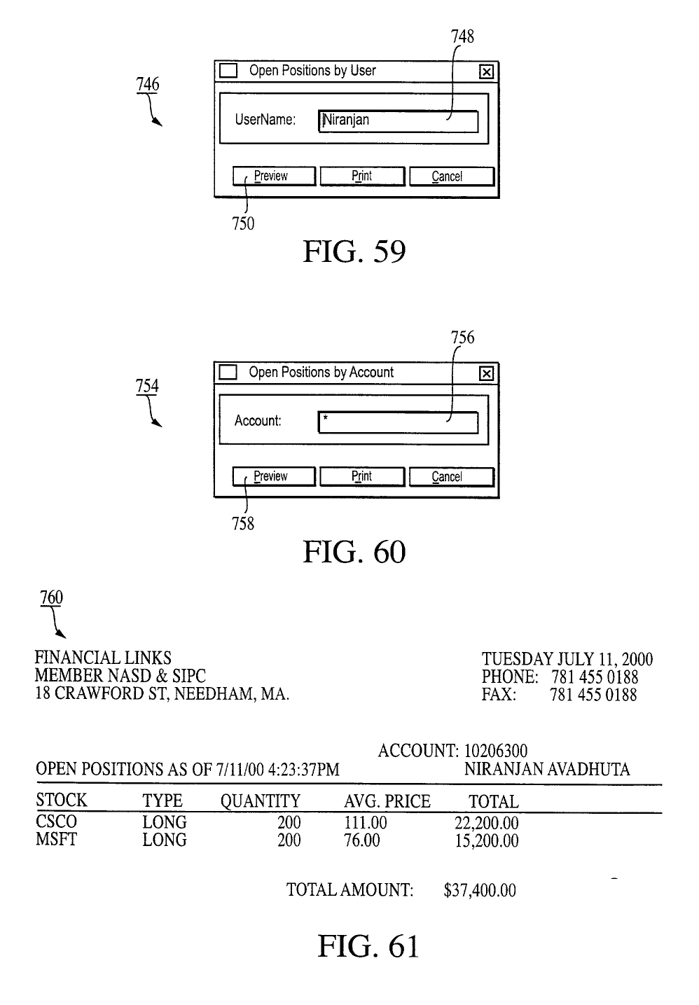

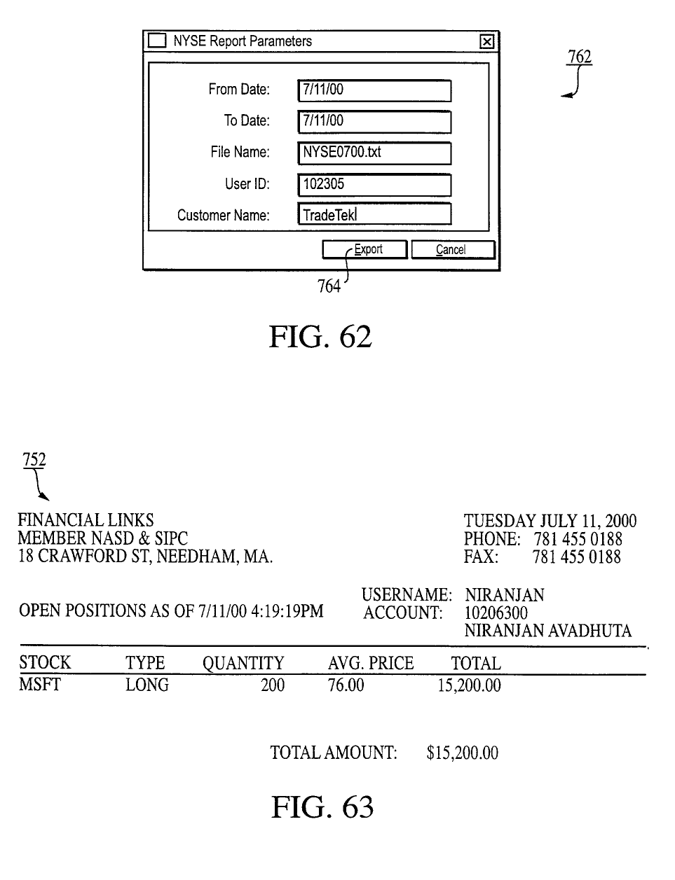

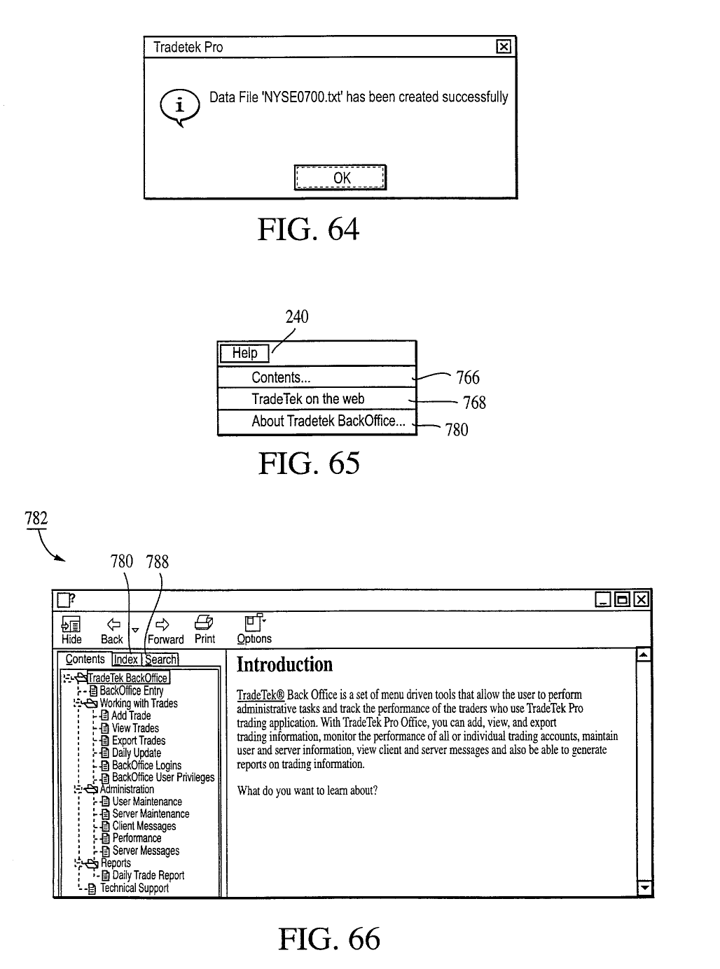

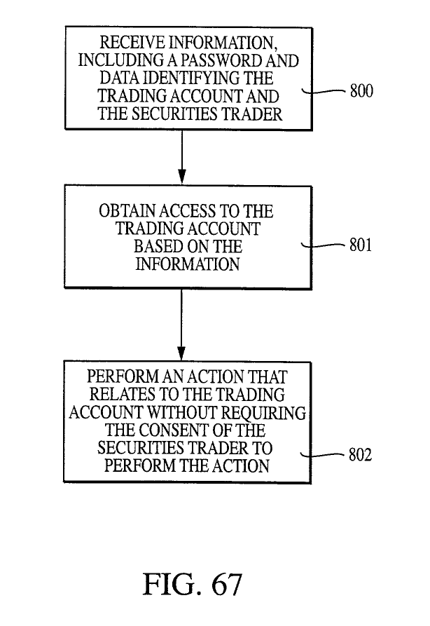

Referring to FIG. 67, a process is shown that can be implemented by computer programs running on either data feed network 11 or trader network 12. The process of FIG. 67 allows an account administrator to control a trading account owned by a securities trader and to configure settings, privileges, and the like of computers/traders on network 10. The process includes receiving (800) information including a password and data identifying the trading account and the securities trader, obtaining (801) access to the trading account based on the information, and performing (802) an action that relates to the trading account without requiring the consent of the securities trader to perform the action. What this means is that the account administrator can perform actions with respect to the trading account without first receiving the permission of the account owner, although such permission may be obtained beforehand and, may in fact, be required by law. The specific information and actions that the administrator may perform are described below with reference to FIG. 1 and the GUIs of FIGS. 3 to 66.

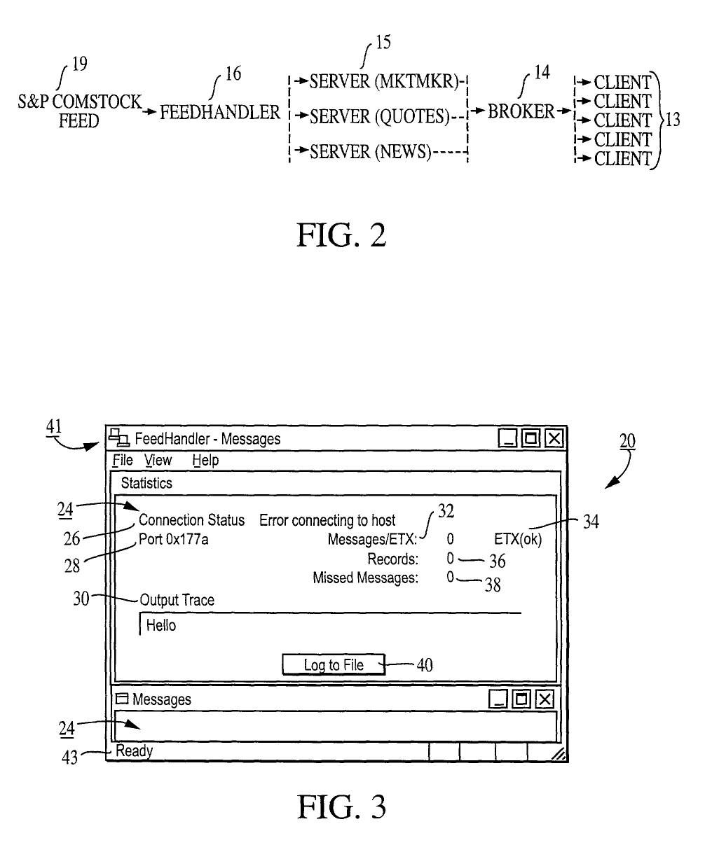

Data feed network 11 includes broker 14, servers 15, feed handler 16, and satellite receiver 17. FIG. 2 shows, conceptually, data flow from components of data feed network 11 to traders (i.e., clients) 13 on trader network 12. In this embodiment, broker 14, servers 15 and feed handler 16 are computer programs that can be run on the same computer or on separate computers of network 11.

Satellite receiver 17 maintains an RF (radio frequency) link to a communications satellite (not shown). A data feed 19, such as the Standard & Poor (S&P) Comstock data feed, is received by satellite receiver 17 over this RF link. Alternatively, data feed 19 may be received over telephone lines, cable lines, or any other communications media in communication with data feed network 11. Data feeds other than the S&P data feed may be used.

Data feed 19 includes information relating to securities, such as stocks. Information in the data feed is time-indexed and updated periodically. Among the information transmitted in data feed 19 are stock prices, identities of market makers (also referred to as “MM” herein) that offer the stock prices, and stock exchanges on which the stocks are listed. A market maker is a person or entity that owns a large enough percentage of a stock to enable the market maker to set, or greatly affect, the price of the stock on the market.

Data feed 19 is provided to servers 15 via satellite receiver 17 and feed handler 16. Feed handler 16 converts data in data feed 19 to a standard format, such as LightSpeed (LSDATA). LSDATA format is a standard format that is used for packaging trading data, transmitting that data, and populating a data structure. Feed handler 16 sends this formatted data to one or more of servers 15. Servers 15 cache the formatted data to satisfy client requests received via broker 14 (described below).

During operation, feed handler 16 displays the STATISTICS AND MESSAGES dialog box 20 shown in FIG. 3. An account administrator can configure the system using STATISTICS AND MESSAGES dialog box 20. STATISTICS AND MESSAGES dialog box 20 includes a STATISTICS portion 22 and a MESSAGES portion 24. Among the information displayed in STATISTICS portion 22 is the status 26 of the connection to the data feed (e.g. “connecting”, “connected to host”, or “error connecting to host”), the identity 28 of the port on which the feed is being received, and an output trace 30. In this embodiment, trace 30 is a display of data from data feed 19 that is updated every 10 seconds. Output trace 30 is used to confirm the flow of, and connection to, data feed 19.

STATISTICS portion 22 also displays a message count 32. The message count is the number of data feed messages received by feed handler 16. A “message”, in this embodiment, is a data feed record that has been converted to LSDATA format. Each message can contain one or more data feed records. In feed handler 16, “ETX” endings are appended to messages. Feed handler 16 keeps a running count of the number of messages, which are identified by their “ETX” endings. On the STATISTICS portion, ETX status indicator 34 displays an “ok” message, e.g., “ETX(ok)”, if the message count received by feed handler 16 equals the ETX count, otherwise it displays the ETX count to show the disparity between messages and ETXs. A disparity indicates that that message(s) may have been lost or dropped. STATISTICS portion 22 also displays the total number 36 of data feed records received and the number of missed messages 38. Each S&P message has a number that is incremented by one in the message sequence relative to the previous S&P message. MISSED MESSAGES 38 displays the number of gaps in that sequence.

MESSAGES portion 24 displays data feed records that have been converted to LSDATA format. LOG TO FILE BUTTON 40 causes feed handler 16 to store S&P formatted records and LSDATA formatted records in a log file. The log file is stored in memory on a computer that runs feed handler 16. Alternatively, the log file may be stored on the memory of another machine on network 10.

FIGS. 4 to 6 show menu options 41 available on STATISTICS AND MESSAGES dialog box 20. In FIG. 4, FILE menu 42 contains an option 44 for exiting from feed handler 16. VIEW menu 46 includes STATUS BAR option 48 which causes feed handler 16 to toggle on and off (meaning display or not display) the feed handler status bar 43, which indicates the status, e.g., “Ready”, of feed handler 16. View menu 46 includes FEED STATISTICS option 50 which causes feed handler 16 to toggle STATISTICS portion 22 on and off, MESSAGES option 52 which causes feed handler 16 to toggle MESSAGES portion 24 on and off, and PROPERTIES option 54 which causes feed handler 16 to display EXCHANGE PROPERTIES dialog box 56 (FIG. 7).

On EXCHANGE PROPERTIES dialog box 56, TRACE tab 58 allows the administrator to select the data feed records 60 that feed handler 16 stores in the statistics view trace buffer (not shown). The trace buffer is a memory, e.g., on a computer running feed handler 16, that stores, at least temporarily, data from feed 19 that is displayed at output trace 30. PROCESS tab 62 allows the administrator to select which data feed records 60 that feed handler 16 processes into LSDATA. LOG tab 64 allows the administrator to select which data feed records 60 that feed handler 16 stores when LOG TO FILE BUTTON 40 (FIG. 3) is selected.

Referring back to FIG. 1a, servers 15 are computer programs that receive formatted S&P data from feed handler 16 and provide that data to trader network 12. For example, quote servers 15a and 15b handle current stock prices and information relating thereto. Level II servers 15c and 15d handle market maker information, such as bid prices (the highest price a market maker is willing to pay for a stock) and ask prices (the lowest price a market maker is willing to sell a stock). History server 15e maintains a record of stock prices over a period of time, including previous stock highs and lows, stock volumes, previous closing prices (PCLs), and the like. NYSE (New York Stock Exchange) quote server 15f handles information relating to stocks listed on the NYSE. Six servers are shown in FIG. 1a; however, servers may be added to, or removed from, data feed network 11 as desired.

Servers 15 may be executed on a single computer or multiple computers as needed. They may be executed on the same or different computers as feed handler 16 and broker 14. In this embodiment, each server is executed on a separate computer having a processor 20 and a memory 21 that stores executable instructions 22 (see view 24). The instructions operate to receive data from feed handler 16, store the data in memory, handle requests for data from trader network 12, and provide the requested data in response to the requests. For example, when server 15a receives a request for data, instructions 22 determine what data is being requested and from where, retrieve the requested data from memory, and output the requested data to the requester.

In this embodiment, instructions 22 are implemented in a computer program called LSDSERVER. LSDSERVER receives LSDATA from feed handler 16. LSDSERVER caches this data and uses it to satisfy requests from broker 14, as noted above. One or more copies of LSDSERVER can reside on a single computer, making it possible for that computer to implement multiple server functions, as noted.

During operation, LSDSERVER displays the STATISTICS AND MESSAGES dialog box 66 shown in FIG. 8. As was the case above, STATISTICS AND MESSAGES dialog box 66 contains a STATISTICS portion 68 and a MESSAGES portion 70. Among the information displayed in STATISTICS portion 68 is the status 72 of the connection to a port 74 on broker 14 (e.g., “connecting”, “connected to host”, “error connecting to host”, or “error opening broker port”), the identity 74 of the port, and output trace 76, which is the same as output trace 30 described above.

STATISTICS portion 68 also displays a message count 78, which is the number of S&P feed messages received by LSDSERVER from feed handler 16. STATISTICS portion 68 displays the total number 80 of data feed records received from feed handler 16 and missed messages 82 (described above).

The MESSAGES portion 70 of dialog box 66 displays records that have been converted to LSDATA format. When selected, LOG TO FILE button 84 causes LSDSERVER to store S&P formatted records and LSDATA formatted records in a log file in memory on network 10. In this embodiment, the log file is stored in memory on the computer executing LSDSERVER; however, the invention is not limited as such.

FIGS. 9, 10, 13 and 14 show menu options 61 that are available on STATISTICS AND MESSAGES dialog box 66. Referring to FIG. 9, SERVER menu 86 provides an option 88 for the administrator to EXIT LSDSERVER and an option 90 to RECONNECT LSDSERVER to feed handler 16. The RECONNECT option 90 is used, e.g., if the connection between LSDSERVER and broker 14 is lost.

VIEW menu 92 includes STATUS BAR option 94 which causes LSDSERVER to toggle the server status bar 71 (see FIG. 8) on and off, DATA SERVER STASTISTICS option 96 which causes LSDSERVER to toggle STATISTICS portion 68 on and off, MESSAGES option 98 which causes LSDSERVER to toggle MESSAGES portion 70 on and off, PROPERTIES option 100 which causes LSDSERVER to generate and display EXCHANGE PROPERTIES dialog box 102 (FIG. 11), and BROKER LIST option 104 which causes LSDSERVER to display a dialog box 106 (FIG. 12) containing a list 108 of brokers connected to the server (only one broker, LSBROKER1, is shown in the list of FIG. 12).

On EXCHANGE PROPERTIES dialog box 102 (FIG. 11), TRACE tab 110 allows the administrator to select which data feed records 112 LSDSERVER stores in a statistics view trace buffer, which is similar to the trace buffer described above. PROCESS tab 114 allows the administrator to select which data feed records 112 that the administrator wants LSDSERVER to process and cache. LOG tab 116 allows the administrator to select which data feed records 112 LSDSERVER 16 stores when LOG TO FILE button 84 (FIG. 8) is selected.

ADMIN menu 118 (FIG. 13) allows the administrator to enter an administrative menu. The Administrative menu includes options to WRITE MM DATABASE 120 (add or modify the identity of market makers accessible to traders in the system), ERASE MM DATABASE 122 (remove access to a market maker), and CLEAR MM CACHE 124 (clear market maker information from temporary storage).

FIG. 14 shows HELP menu 125. Help menu 125 provides the user with information about LSDSERVER.

Referring back to FIG. 1a, broker 14 is a computer program, executing on one or more computers, which mediates requests for information between trader network 12 and data feed network 11. For example, broker 14 directs requests from traders/clients to appropriate server(s) based on the content of those requests. Broker 14 also directs data from the servers back to the appropriate client in response to such requests. Broker 14 may also perform any protocol conversions or other processing required for communicating between data feed network 11 and trader network 12.

During operation, broker 14 displays the STATISTICS AND MESSAGES dialog box 126 shown in FIG. 15. As was the case above, STATISTICS AND MESSAGES dialog box 126 contains a STATISTICS portion 128 and a MESSAGES portion 130. Among the information displayed in STATISTICS portion 128 is a message count 132, which is the number of data feed records received from an LSDSERVER. STATISTICS portion 128 also displays the total number 134 of data feed records received from the LSDSERVER, along with the number of missed messages 136 (same as above). SERVER CONNECTIONS 140 indicates the number of servers in communication with broker 14 and CLIENT CONNECTIONS 142 indicates the number of clients (e.g., traders) in communication with broker 14.

MESSAGES portion 130 displays data feed records that have been converted to LSDATA format. LOG TO FILE button 138 causes broker 14 to store S&P formatted records and LSDATA formatted records in a log file in memory on the network 10. In this embodiment, the log file is stored on the computer that runs LSDSERVER. LSDSERVER sends the log file to a client (e.g., trader) in response to a request from that client for information contained therein.

FIGS. 16 and 17 show menu options 143 that are available on STATISTICS AND MESSAGES dialog box 126. Referring to FIG. 16, broker menu 144 allows the administrator to exit broker 14, to connect to a server, and to view a list clients connected to broker 14. Selecting CONNECT option 146 causes broker 14 to generate and display the CONNECT dialog box 148 shown in FIG. 18. CONNECT dialog box 148 displays the IP (Internet Protocol) address, port, and status of each server to which broker 14 is connected. Entering the IP address of a server next to its name (e.g., 150) and clicking on CONNECT 152 causes broker 14 to connect that server to the broker and, thus, to network 10. Clicking on DISCONNECT 154 causes broker 14 to disconnect from that server.

Selecting LIST CLIENTS option 156 from menu 144 (FIG. 16) causes broker 14 to generate and display dialog box 158 (FIG. 19). Dialog box 158 lists an IP address/port 160 on broker 14, clients 162 connected to the broker via that IP address/port, and their status (e.g., “live”).

In FIG. 17, selecting VIEW menu 164 causes broker 14 to provide options including STATUS BAR 166, STATISTICS 168, and MESSAGES 170. Selecting STATUS BAR option 166 causes broker 14 to toggle the broker status bar 131 (FIG. 15) on and off. Selecting STATISTICS option 168 causes broker 14 to toggle STATISTICS portion 128 (FIG. 15) on and off. Selecting MESSAGES option 170 causes broker 14 to toggle MESSAGES portion 130 (FIG. 15) on and off.

Referring now to FIG. 1b, trader network 12 includes frame relay connection 172, database server 174, execution servers 176, authentication server 178, and Internet connection 179. These components are computer programs that may be implemented on one or more computers; however, in this embodiment, each program is shown as operating on a separate computer.

Terminals 13 are personal computers (“PC”). Alternatively, they may be “dumb” terminals of a mainframe computer or any other type of computing device that is capable of processing and displaying information. As shown in close-up view 180, a terminal 13a includes a processor 182 and a memory 184 that stores computer-executable instructions, namely trading code 186.

Trading code 186 generates various GUIs that are used by a trader to request information relating to stocks, to view that information, and to transact in stocks. GUIs that are generated by trading code 186 for use by traders are described in U.S. patent application Ser. No. 09/686,545, filed on Oct. 11, 2000, the contents of which are hereby incorporated by reference into this application.

Trading code 186 also enables an account administrator to perform various tasks relating to online trading from a terminal 13 or any other computer on network 10. These tasks may be performed with respect to an account owned by a trader on the network and they may be performed without requiring the consent of the trader (although the trader's consent may be obtained, if necessary or desired). Examples of these tasks include monitoring the performance of brokerage accounts and individual traders; adding, removing, modifying and suspending trading privileges; and viewing, exporting, and archiving trading activity information. These tasks, and the GUIs to perform them, are described in detail below.

Frame relay connection 172 connects networks 11 and 12 to related network 188 via a dedicated line or virtual private network (VPN). The components shown in FIG. 1 may be included at one site, such as a building or office. Frame relay connection 172 enables remote traders to access services available at that site via network 188.

Execution servers 176 are computer programs that receive transaction requests from trader terminals 13 and forward such requests to specified market networks 190. In the embodiment shown in FIG. 1, there is a one-to-one correspondence between execution servers and market networks or trading systems. For example, Archipelago® has its own server and Island® has its own server. However, this is not a requirement. For example, one server may support more than one market network or two servers may support the same market network. Likewise, a single computer (with processor and memory) may be used to execute a single execution server, a combination of execution servers, or all of execution servers 176.

Authentication server 178 is a computer program for determining the identity of traders (or other users) when they log into trader network 12. For example, at login, a terminal 13a will display window 194 (FIG. 20) to a user. The user, in this case an account administrator, enters a password and user ID (IDentifier) to enter trader network 12. This information is passed to authentication server 178, which uses it to determine if the administrator is authorized to access trader network 12. If the administrator is so authorized, server 178 permits access to trader network 12; otherwise access is denied.

Database server 174 maintains a record of transactions executed on trader network 12. Database server 174 may be implemented on a computer that contains a memory for storing transaction records and a processor for retrieving that information upon request. Each time a transaction takes place, information is provided to database server 174 identifying the transaction (e.g., by stock, number of shares traded, price, etc.) and the trader. This information is stored in a transaction record maintained by database server 174.

Internet connection 178 includes standard hardware and/or software for maintaining a connection, such as a VPN, to remote traders on the Internet 196. For example, one or more Internet servers 198 may be provided, which pass data between trader network 12 and the Internet, thereby allowing traders on the Internet to access the services available on trader network 12 and vice versa. Mail server 200 controls the transmission of electronic mail between trader network 12 and the Internet. Firewall 202 is provided for security purposes, and performs packet filtering and the like to keep unauthorized users from accessing trader network 12. A T1 line or any other medium 204 provides high-speed (or other) Internet access.

Referring to FIG. 1, trading code 186 generates a BACK OFFICE icon (not shown) on a trader's terminal/client 13. An administrator double-clicks on this icon to enter an application that allows the administrator to perform the tasks relating to online trading noted above. When the icon is double-clicked, trading code 186 generates GUI 194 (FIG. 20), which was mentioned above.

GUI 194 is a login screen, which includes a field 206 for entering the administrator's LOGIN ID and a field 208 for entering the administrator's PASSWORD. OK button 210 enters the information into the system. Cancel button 212 cancels the operation. ODBC (Open Database Connectivity) button 214 displays dialog box 226 (FIG. 21). Dialog box 226 displays SERVER 216, DATABASE 218, DATABASE LOGIN 220, and DATABASE PASSWORD 222 information. Dialog box 226 allows the account administrator to change the displayed server information, e.g., to add, delete, or modify a server.

Trading code 186 provides the administrator's identification information, namely the ID and password, to authentication server 178, where they are authenticated. Once the administrator's access to system resources has been approved, trading code 186 generates and displays GUI 228 (FIG. 22) to the administrator.

As shown in FIG. 22, GUI 228 includes a date indicator 230. Date indicator 230 is typically displayed to the right of MAIN MENU bar 232. Date indicator 230 displays the current date and day. MAIN MENU bar 232 provides drop-down menus that are segmented into four categories: APPLICATION 234, TOOLS 236, REPORTS 238, and HELP 240. Main menu 232 also includes a toolbar 242 with buttons for frequently used commands. From left to right, the six toolbar buttons implement the following functions: ADD TRADE(S) 248, VIEW TRADES 250, EXPORT TRADES 252, USER MAINTENANCE 254, SERVER MAINTENANCE 256, and GLOBAL PERFORMANCE 258. Descriptions of the functions available by way of main menu 232 are provided below.

Referring to FIG. 23, the options available from APPLICATION menu 234 are shown. As shown, these options include ADD TRADE 260, SUBMIT TRADE 262, VIEW TRADES 264, EXPORT TRADES 266, DAILY UPDATE 268, LOGINS 270, PRIVILEGES 272, and EXIT 274. Selecting ADD TRADE 260 from APPLICATION menu 234 causes trading code 186 to generate and display ADD TRADE dialog box 276 (FIG. 24). This dialog box can also be displayed by clicking on add trade(s) icon 248 on toolbar 242. From ADD TRADE dialog box 276, an administrator can input trade information manually, which trading code 186 sends to database server 184 when the administrator clicks SAVE button 278. An administrator may enter trade information in this fashion for reporting purposes, in order to balance accounts, or if an error with an execution server or other difficulty results in missing trade information.

The information includes a stock identifier 280 (STKID); a quantity 282 of stock involved in the trade; a price 284 of the stock; a market maker identifier (MMID) 285 that identifies a market maker associated with the trade; a transaction number 286 assigned to the trade; the name 288 of the administrator (USERNAME); an action 290 being performed with respect to the stock, such as bought 292 (BOT), sold 294 (SLD), and sold short 296 (SSHRT); the amount 298 of a trade in stock that cannot be filled (LEAVES); a sequence number 299 (SEQNUM) assigned to the trade; a type 300 (TYPE) of trade, e.g., bought, sold, shorted; the identity 301 of the market, e.g., Island®, on which the trade is executed; and the date and time 306 of the transaction (DATETIME, DATE and TIME). CLEAR button 308 clears the information entered into dialog box 276 without saving it. SAVE button 278 saves the information to database server 174. EXIT button 310 closes dialog box 276 without saving the information. CLEAR button 308, EXIT button 310, and SAVE button 278 have the same functions on many of the GUIs described herein. Therefore, a description of those functions is not repeated every time those buttons appear on a GUI.

Selecting SUBMIT TRADE option 262 from APPLICATION menu 234 (FIG. 23) causes trading code 186 to generate and display the SUBMIT TRADE dialog box 312 shown in FIG. 25. From SUBMIT TRADE dialog box 312, an administrator can execute a trade for a specific account and have that trade sent directly to an execution server 176, from which that trade is executed (i.e., made). An administrator may take this action from the administrator's own system, e.g., on behalf of a trader who is temporarily unable to trade or who has had trading privileges suspended.

In order to execute a trade from SUBMIT TRADE dialog box 312, the administrator enters a STOCK ID 314, QUANTITY 316, PRICE 318, and SERVER INFORMATION 322 into the appropriate fields. SERVER INFORMATION 322 shows the mode of execution of the trade. That is, trading code 186 may select an execution server 179 (e.g., Island®—ISLD) automatically based on a number of criteria, such as which service provides the lowest price for a stock. SERVER INFORMATION 322 is therefore provided to indicate the service/server that was selected.

The administrator selects an option 324 from ACTION drop-down menu 326 and clicks on SAVE button 328. By clicking on SAVE button 328, the selected trade is executed and information identifying the trade, such as the information input to dialog box 312, is saved to database server 174 automatically. If the REPORT TO CLIENT box 330 is selected when a save takes place, notification of the executed trade will also be sent to the client on whose behalf the trade was executed. Trading code 186 also displays the name 320 of the administrator (USERNAME) and the date and time 321 of the transaction (DATETIME).

Selecting VIEW TRADES option 264 from APPLICATION menu 234 (FIG. 23) causes trading code 186 to generate and display the VIEW TRADES dialog box 332 shown in FIG. 26. This dialog box can also be displayed by clicking on the view trades button 250 on toolbar 242 (FIG. 22). From the TRADES drop-down menu 334 on dialog box 332, the administrator can choose to view real-time, live trade data or archived trade information. Archived information includes, e.g., a record of trades made over a particular time period, the identity of the trader making those trades, the cost and number of shares involved, etc.

Entering a date 336 (day/month/year) for which there is non-archived trade information and clicking SHOW button 338 causes trading code 186 to generate and display an attached dialog box 340 with seventeen columns that can be scrolled through horizontally using horizontal directional arrow keys (not shown). The seventeen column headings 342 are shown in FIG. 27. They include a stock identifier 344 (STKID); a quantity 346 of stock involved in a trade; a price 348 of the stock; a MMID 350; a transaction number 352 assigned to the trade; an account 356 with which the transaction is associated; an action 358 being performed with respect to the stock, such as bought (BOT), sold (SLD), and sold short (SSHRT); the date 360 of the transaction; the time 362 of the transaction; the combined date and time 364 (DateTime); LEAVES 365 and SEQNUM 366 defined above; an indication 368 of whether an entire order of stock was filled (MATCHED); a price 370 at which trading in the stock stops automatically (STOPVALUE); a price at which a stock was actually purchased (NPRICE); a type 365 of transaction (e.g., bought, sold, shorted); and a table index 374 (TBLINDEX). TBLINDEX 374 is a unique identifier (ID) that trading code 186 stores for a table that contains data (e.g., price, time, quantity, execution method, etc.) pertaining to each individual trade. TBLINDEX 374 number is stored in a relational database located on a computer running LSDSERVER. TBLINDEX 374 allows trading code 186 to find all related information stored, e.g., by database server 174 that pertains to a specific trade.

The SORT BY drop-down menu 376 shown in FIG. 26 allows the administrator to sort and view non-archived trading activity for a given date by transaction number (TRANSNUM—shown), stock symbol (not shown), and account number (not shown).

Selecting EXPORT TRADES 266 from APPLICATION menu 234 (FIG. 23) causes trading code 186 to generate and display the EXPORT TRADES dialog box 378 shown in FIG. 28. This dialog box 378 can also be displayed by clicking on the export trades button 252 on toolbar 242 (FIG. 22). Entering a date 380 (day/month/year) for which there is non-archived trade information and clicking SHOW button 382 causes trading code 186 to generate and display attached dialog box 383. Dialog box 383 contains seventeen columns 385 that can be scrolled through horizontally using horizontal directional arrow keys (not shown). Using this dialog box, an administrator can view all of the data that is available for export. The seventeen columns are the same as those described above with respect to FIG. 27. A description of those columns is therefore not repeated here.

Order Audit Trade System (OATS), or any other available reporting scheme, may be used to report the information from dialog box 378 to a third party. OATS reports daily trade information to NASDAQ® in order to confirm that the trades made by traders on network 10 match the information maintained by NASDAQ®. The REPORTING DATE 380 may be changed manually if reporting requirements require the date to be changed. With OATS reporting, the administrator may select a specific file name 384 and file type 386 from the OATS drop-down menu 388. When EXPORT button 390 is selected, trading code 186 generates an export file and saves the export file on the administrator's local directory. The resulting filename includes the date and an assigned sequential file number.

Selecting DAILY UPDATE option 268 from APPLICATION menu 234 (FIG. 23) causes trading code 186 to generate and display DAILY UPDATE dialog box 392 (FIG. 29). DAILY UPDATE dialog box 392 includes UPDATE PORTFOLIO section 394, VIEW PORTFOLIO section 396, CLEAR ARCHIVED TRADES section 398, and ARCHIVE TRADES section 400.

Selecting UPDATE button 402 from UPDATE PORTFOLIO section 394 causes trading code 186 to update the portfolio of all accounts with currently-open positions. It is also possible to update a day's portfolio information by manually changing the date in LAST TRADE DATE field 404 to a past date when an update was not executed. If two or more consecutive days pass without an update occurring, updates may be performed manually by changing LAST TRADE DATE 404 to the earliest date that an update was not run, running the update portfolio function for the earliest date, and repeating updating for each missed day moving forward sequentially one day at a time.

Selecting ARCHIVE button 406 in ARCHIVE TRADES section 400 stores active trade information that is more than three days old. The archived information may be stored in the hard drive of a computer running trading code 186. Three days is selected because it takes three days for a trade to officially settle. When trades are archived for a given day, the resulting archive information is placed in a temporary table. Each sequential day's data is added to the same table when it is archived until a decision is made to clear the table. Trading code 186 clears the table in response to the administrator clicking on CLEAR button 408 in CLEAR ARCHIVED TRADES section 398.

VIEW button 410 in VIEW PORTFOLIO section 396 allows the administrator to view the current status of any trader's portfolio at any time. The administrator can view the status by selecting a trader by name from VIEW PORTFOLIO drop-down menu 412 and clicking on VIEW button 410. When this is done, trading code 186 displays dialog box 414 shown in FIG. 30. Dialog box 414 displays information about the portfolio of a trader 416. The information includes the stocks 418 (STKID) in that portfolio, the quantity 420 of each stock, the price 422 (i.e., value) of each stock, and the day and date 424 that the stock was added to the portfolio.

Selecting LOGINS 270 from APPLICATION menu 234 (FIG. 23) causes trading code 186 to generate and display LOGIN dialog box 426 (FIG. 31). LOGINS dialog box 426 allows an administrator to set up new user login and access options and to modify or delete such information for existing traders, or other users, on the system. From dialog box 426, a login name 428, password 430, and basic or administrative privileges designations 432 can be established. The list of remaining default access options that may be assigned to a user following login includes: ADD TRADES 434, BACK OFFICE LOGINS 436, BACK OFFICE PRIVILEGES 438, CLIENT MESSAGES 440, DAILY TRADE REPORT 442, DAILY UPDATES 444, EXPORT TRADES 446, GLOBAL PERFORMANCE 448, INDIVIDUAL PERFORMANCE 450, SERVER MAINTENANCE 452, SERVER MESSAGES 454, SET BUYING POWER 456, USER MAINTENANCE 458, and VIEW TRADES 460. These options allow the account administrator to set user privileges relating to the titles of the options.

For trading code 186 to set up a new user (e.g., trader), the administrator enters a unique login name, chooses access options to assign to the new user in ASSOCIATED OPTIONS list 464 from REMAINING OPTIONS list 462, and clicks SAVE 466. For trading code 186 to modify privileges, the administrator selects a user (trader) from LOGIN NAME drop-down menu 428, adds or removes options to the ASSOCIATED OPTIONS list 464 from the REMAINING OPTIONS list 462, and then clicks SAVE 466. For trading code 186 to delete a user, the administrator selects a user from the LOGIN NAME drop-down menu 428, and clicks DELETE 468. Trading code 186 then generates a dialog box (not shown). The dialog box asks the administrator to confirm that the selected name is to be deleted. Clicking YES, or an equivalent, in that dialog box causes trading code 186 to remove the user from the system.

Selecting PRIVILEGES 272 from APPLICATION menu 234 (FIG. 23) causes trading code 186 to generate and display PRIVILEGES dialog box 470 (FIG. 32). From this dialog box 470, the administrator can add, remove or delete privileges that appear as options in LOGIN dialog box 426 (FIG. 31) when ADMIN (i.e., administrator) or BASICUSER (i.e., basic user) privileges are selected for a given user. It is noted that administrators are generally given more privileges than basic users (i.e., traders). Changes made to ASSOCIATED OPTIONS list 464 or REMAINING OPTIONS list 462 in PRIVILEGES dialog box 470 are added or removed automatically as options from the corresponding boxes on LOGIN dialog box 426 when SAVE 472 is clicked on PRIVILEGES dialog box 470.

Selecting EXIT 274 from the APPLICATION menu 234 (FIG. 23) causes trading code 186 to exit the administrator from the system.

Referring now to FIG. 33, options available through TOOLS pull-down menu 236 are shown. TOOLS menu 236 has ten drop-down options: SET BUYING POWER 472, SET REGISTRY VALUES 474, BROKER COMMISSIONS 476, COMBINE TRADES 478, USER MAINTENANCE 480, SERVER MAINTENANCE 482, CLIENT MESSAGES 484, SERVER MESSAGES 486, INDIVIDUAL PERFORMANCE 488, and GLOBAL PERFORMANCE 490.

Selecting SET BUYING POWER 472 from TOOLS menu 236 causes trading code 186 to generate and display the SET BUYING POWER dialog box 492 shown in FIG. 34. From this dialog box, the administrator can set the buying power for an individual trader or account. To change the buying power of a user, the administrator 493 selects a user name by scrolling through the list of available user (trader) names using arrow keys 494, enters a buying limit in the BUYING LIMIT field 496 for the user, and clicks EXIT button 498. Once EXIT button 498 is clicked, trading code 186 saves the new buying power limit for the user.

Selecting SET REGISTRY VALUES 474 from TOOLS menu 236 (FIG. 33) causes trading code 186 to generate and display the REGISTRY CHANGES dialog box 500 (FIG. 35). From this dialog box, the administrator can add or reconfigure execution servers to a broker dealer's database. This allows the administrator to determine where a trade was executed and remove execution charges.

Selecting BROKER COMMISSIONS 476 from TOOLS menu 236 (FIG. 33) causes trading code 186 to generate and display the BROKER COMMISSIONS dialog box 530 shown in FIG. 36. From this dialog box, the administrator can set trade execution and market-related fees; such as the commission 532 for broker 534.

Selecting COMBINE TRADES 478 from TOOLS menu 236 (FIG. 33) causes trading code 186 to generate and display the COMBINE TRADES dialog box 536 shown in FIG. 37. From this dialog box, the administrator can combine trades within a given clearing firm's parameters to minimize tickets when there are multiple fills. This allows the administrator to combine trades and have the trade orders filled as a single order, thereby saving commission fees. If the administrator enters the time 538 and maximum share information 540 and clicks OK button 542, trading code 186 generates the message 544 shown in FIG. 38 to indicate that combining was performed successfully.

Selecting USER MAINTENANCE 480 from TOOLS menu 236 (FIG. 33) causes trading code 186 to generate and display the USER MAINTENANCE dialog box 546 shown in FIG. 39. Clicking on USER MAINTENANCE button 254 on toolbar 242 (FIG. 22) also causes trading code 186 to generate and display this dialog box. From dialog box 546, the administrator can add, update or delete a trader's account information from fields 548. On dialog box 546, the ACCOUNT TYPE box 550 and MARKET TYPE box 552 both include drop-down menus that allow the administrator to select specific options that apply to a given user (e.g., trader). The account information includes, but is not limited to, one or more of a user name, a password, a buying limit, a commission fee, an account number, an account type, and connections to market maker servers.

To cause trading code 186 to add a new user (e.g., trader), the administrator presses CLEAR button 554 and fills in fields 548 with appropriate information. Clicking SAVE 556 completes the task of adding the new user. To update an existing user, the administrator selects the name of the user to be updated from USER NAME drop-down menu 560. This causes trading code 186 to populate fields 548 with existing (i.e., stored) information that pertains to the selected user. The administrator makes the desired modifications and clicks save 556 to cause trading code 186 to update and save the modifications. To delete a user, the administrator selects the user's name from USER NAME drop-down menu 560, and clicks DELETE button 562 then SAVE button 556. This causes trading code 186 to delete the user.

Selecting SERVER MAINTENANCE 482 from TOOLS menu 236 (FIG. 33) causes trading code 186 to generate and display the SERVER MAINTENANCE dialog box 564 shown in FIG. 40. Trading code 186 also displays this dialog box 564 in response to the administrator clicking on SERVER MAINTENANCE button 256 of toolbar 242 (FIG. 22). SERVER MAINTENANCE dialog box 564 allows the administrator to add, update or delete an execution server (see FIG. 1).

To add a server, the administrator clears fields 566 by clicking CLEAR button 568. The administrator enters the desired server name 570, IP (Internet Protocol) address 572, and port information 574 in the designated fields, and selects an interface from INTERFACE drop-down menu 576. The administrator clicks save 578 and, in response, trading code 186 saves the newly-entered server information to database server 174.

To cause trading code 186 to update server information, the administrator selects the desired server from server NAME drop-down menu 570. The administrator enters the necessary changes in the appropriate fields 566 and clicks SAVE button 578, thereby causing trading code 186 to save the entered changes to database server 174.

To delete an available server, the administrator selects the server from server NAME drop-down menu 570 and clicks delete button 580, thereby causing trading code 186 to delete the server from the system.

Selecting CLIENT MESSAGES 484 from TOOLS menu 236 (FIG. 33) causes trading code 186 to generate and display the CLIENT MESSAGES dialog box 582 shown in FIG. 41. CLIENT MESSAGES dialog box 582 allows the administrator to view eleven categories of messages for a current or immediately preceding trading day that have been sent from a server 15 to a terminal 13. The eleven columns of data 589, which the administrator may scroll through horizontally by clicking horizontal directional arrow keys (not shown), are depicted in FIG. 42. These include CLIENT 584 (trader identity), STKID 586 (stock identity), ACTION 588 (type of action performed, e.g., bought, sold, shorted), QUANTITY 590 (the amount of stock involved in the transaction), PRICE 592 (the price of the stock in the transaction), MMID 594 (the market maker from whom the stock was purchased), REFERENCE NO. 596, INFO 598, RAWMESSAGE 600, TIME 602 (the time of the purchase), and MSGNUMBER 604. RAWMESSAGE 600 is a string of data with detailed information about a trade that one machine sends to another. The data is untranslated and unformatted. So, the string of data will contain information about what trade took place, at what time, at what price, where the trade was executed, how many shares were involved and so on. The data is sent as a single string between machines, such as between a trader's computer and a source of execution (ARCA®, SOES®, Island®, etc.). The machines at either end can then take actions based on the sent string of data or parse and display the information in ways that are easily understood by an end user. MSGNUMBER 604 is a sequence number assigned to each message. A message might indicate the status of a trade such as, bought, sold, cancelled, etc. REFERENCE NO. 596 is a number indicating the identity of a message that may relate to another message identified as MSGNUMBER. For example, a trader might get the message that a trade was cancelled. An additional message related to the cancelled message will be given a REFERENCE NO., which might be an explanation as to why a trade did execute. For example, attempted and canceled trades may exceed a trader's buying power/money in the trader's stock purchase account. INFO 598 is a blank field that is reserved to permit transmission of an unusual or otherwise unanticipated message that provides helpful information about a trade that is not covered by the messages described above.

To view messages for a given client, the account administrator inputs a client to CLIENT field 606, selects the appropriate server from SERVER drop-down menu 608, and selects “today” or “yesterday” from DATE drop-down menu 610. The administrator then enters a specific single stock ID or an asterisk (*) wild-card symbol in stock ID field 612 to retrieve information on one specific stock or on all stocks 614 for the designated date for which information was provided by the server to a client.

Selecting SERVER MESSAGES 486 from TOOLS menu 236 (FIG. 33) causes trading code 186 to generate and display the server messages dialog box 616 shown in FIG. 43. Dialog box 616 displays message information comprised of messages between an execution server and an execution source in order to verify that a trade was executed. The server messages dialog box 616 allows the administrator to view ten categories of message information for the current or immediately preceding trading day. The ten columns of data 618 that the administrator may scroll through horizontally by clicking horizontal directional arrow keys are shown in FIG. 44. These columns include DATE 620 (the date of the message), SENDER 622 (the identity of the trader), TYPE 624 (the type, e.g., bought, sold, etc.), SYMBOL 626 (stock ID), SEQNUM 628 (sequence number), ADMINFLAG 630 (an indication that that there was a problem with the trade), REJECTED 632 (an indication that that the trade was rejected), SERVERID 634 (the identity of the execution server from which the trade was executed), CLIENT 636 (the identity of the trader), and MESSAGE 638 (the contents of an unspecified message).

Selecting INDIVIDUAL PERFORMANCE 488 from TOOLS menu 236 (FIG. 33) allows the administrator to run an individual performance report sorted by user (e.g., trader) name or by account number. Selecting BY USER option 640 from INDIVIDUAL PERFORMANCE menu 488 (FIG. 45) causes trading code 186 to generate and display INDIVIDUAL PERFORMANCE dialog box 642 (FIG. 46). Dialog box 642 includes a field 644 for entering a user's name (USERNAME). If a valid user name is entered in that field and SHOW button 646 is clicked, trading code 186 populates dialog box 642 with values for STARTING BALANCE 644 (starting balance of the account), CURRENT BALANCE 646 (current balance of the account), EXPOSURE 648, NET CHANGE 650 (change in account balance), and NET PERCENTAGE INFORMATION 652 (percentage of change of the balance of the account) for a selected user. If DISABLE button 654 is selected, trading code 186 disables the trading privileges of the selected user.

EXPOSURE 648 deals with a trader's financial situation based on stocks that the trader owns or must to buy or sell. For example, if the trader starts the day with $100,000, buys stocks that cost that amount, and then the stocks drop in value by 10%, the trader has $10,000 of exposure/loss at that point in time. Traders can also short stocks, which is basically a procedure where they sell stocks they do not presently own with a promise to buy an equal number shares later to cover the sale and make everything balance out. A trader will short a stock when that trader believes that its value is about to drop. So, a trader may short 100 shares of stock X at $50 because the trader believes that the stock will drop to, say, $40, within a specific time frame even though the trader does not yet own the stock. The trader must purchase the stock after that time frame expires. If the trader is right, the trader will make money. However, if the stock starts going up in price, the trader is still obligated to buy those shares at some point, so the trader's exposure is the additional money the trader will need to come up with to buy those shares, as compared to the price at which the trader initially shorted/sold the stock. The bottom line is that EXPOSURE 648 translates into the amount of potential loss in dollar terms that a trader faces based on the present value of stocks that the trader presently owns or is obligated to buy. To quote a dictionary: “Short: borrowing a security (or commodity futures contract) from a broker and selling it, with the understanding that it must later be bought back (hopefully at a lower price) and returned to the broker.” That translates into exposure if the price goes up.

Selecting BY ACCOUNT option 666 from INDIVIDUAL PERFORMANCE menu 488 (FIG. 45) causes trading code 186 to generate and display the INDIVIDUAL PERFORMANCE dialog box 668 shown in FIG. 47. If a valid account number is entered into ACCOUNT field 670 and SHOW button 672 is clicked, trading code 186 populates dialog box 668 with values for STARTING BALANCE 674, CURRENT BALANCE 676, EXPOSURE 678, NET CHANGE 680, and NET PERCENTAGE INFORMATION 682 for the selected account. If ENABLE button 684 is clicked, trading code 186 sets the trading privileges for the selected account.

Selecting GLOBAL PERFORMANCE 490 (FIGS. 45 and 48) from TOOLS menu 236 causes trading code 180 to generate and display a GLOBAL PERFORMANCE REPORT sorted by user name or account number. Trading code 186 also generates the GLOBAL PERFORMANCE REPORT in response to the administrator clicking on global performance button 258 on toolbar 242 (see FIG. 22).

Selecting BY USER option 688 from GLOBAL PERFORMANCE menu 490 (FIG. 48) causes trading code 186 to generate and display a GLOBAL PERFORMANCE REPORT 690 (FIG. 49) sorted by user name. From here, the administrator can monitor the real-time performance of all traders in the system. Double-clicking on an individual's NAME 692 causes trading code 186 to generate and display a dialog box 694 (FIG. 50) that permits the administrator to enable 696 or disable 698 trading privileges for a selected trader.

Selecting BY ACCOUNT option 700 from GLOBAL PERFORMANCE menu 490 (FIG. 48) causes trading code 186 to generate and display a GLOBAL PERFORMANCE REPORT 702 (FIG. 51) sorted by account number. Clicking global performance button 258 on toolbar 242 also causes trading code 186 to generate and display a global performance report sorted by account number. From here, an administrator can monitor the real-time performance of all traders in the system. In addition, in response to the administrator double-clicking on a specific displayed account number 704, trading code 186 generates and displays the dialog box 706 of FIG. 52. Trading code 186 enables or disables the selected trader's trading privileges in response to the administrator selecting an appropriate radio button 708 or 710 and clicking OK button 712.

Referring to FIG. 53 showing main menu 232, REPORTS menu 238 allows the administrator to select DAILY TRADE 714, OPEN POSITIONS 716, or NYSE REPORTS 718 from the drop-down menu. Selecting DAILY TRADE 714 from REPORTS drop-down menu 238 allows the administrator to run a daily trade report sorted BY USER name 720 or BY ACCOUNT number 722 (see FIG. 54).

Selecting BY USER option 720 from DAILY TRADE menu 714 causes trading code 186 to generate and display the DAILY TRADE BY USER dialog box 724 shown in FIG. 55. Entering the appropriate information into dialog box 724 and clicking PREVIEW 726 causes trading code 186 to generate and display a DAILY TRADE REPORT 728 (FIG. 56) for the specified trader 730. The report may be printed by selecting PRINT 729. The administrator may elect to have trading code 186 populate the fields of the report with real-time, live trade information or archived information using TRADES drop-down menu 732.

Selecting BY ACCOUNT option 722 from DAILY TRADE menu 714 (FIG. 54) causes trading code 186 to generate and display the DAILY TRADE BY ACCOUNT dialog box 734 shown in FIG. 57. Entering the requested information 736 and clicking PREVIEW 738 causes trading code 186 to generate and display a DAILY TRADE REPORT 740 (see, e.g., FIG. 58) for specified account or accounts. The report may be printed by selecting PRINT 742. The administrator may elect to have trading code 186 populate the fields of report 734 with real-time live trade information or archived information using TRADES drop-down menu 744.

Selecting OPEN POSITIONS 716 BY USER (not shown) from REPORTS drop-down menu 238 (FIG. 53) causes trading code 186 to generate and display the OPEN POSITIONS BY USER dialog box 746 shown in FIG. 59. If a valid user name is entered into USERNAME field 748, and PREVIEW button 750 is clicked, trading code 186 generates and displays the OPEN POSITIONS BY USER report 752 shown in FIG. 63.

Selecting OPEN POSITIONS BY ACCOUNT 722 from REPORTS drop-down menu 238 (FIG. 54) causes trading code 186 to generate and display the OPEN POSITIONS BY ACCOUNT dialog box 754 shown in FIG. 60. If a valid account number is entered into ACCOUNT field 756 and PREVIEW button 758 is selected, the OPEN POSITIONS BY ACCOUNT report 760 of FIG. 61 is generated by trading code 186. In the report shown in FIG. 61, information is displayed for a single account. In alternative embodiments, information may be displayed for multiple accounts.

Selecting NYSE REPORT 718 from the REPORTS drop-down menu 238 (FIG. 53) causes trading code 186 to generate and display the NYSE REPORT PARAMETERS dialog box 762 shown in FIG. 62. Entering the requested information in dialog box 762 and clicking EXPORT 764 causes trading code 186 to create a file for export to the New York Stock Exchange. The file contains reporting information for transmission to the NYSE. The reporting information is similar to that described above for OATS. Trading code 186 also generates and displays a message indicating that the file has been created. An example of that message is shown in FIG. 64.

Referring to FIGS. 22 and 65, HELP pull-down menu 240 has three drop-down options; CONTENTS . . . 766, TRADETEK ON THE WEB 768, and ABOUT TRADETEK BACK OFFICE 780. Selecting CONTENTS . . . 766 from the HELP menu causes trading code 186 to generate and display the HELP dialog box 782 shown in FIG. 66. From here, the administrator can search for information using INDEX 786 or a SEARCH feature 788. The remaining options, namely TRADETEK ON THE WEB 768 and ABOUT TRADETEK BACK OFFICE 780 contain information about the company, in this case TradeTek, LLC, that maintains the system.

The system described herein is not limited to use with the hardware/software/GUI/network configurations of FIGS. 1 to 67; it may find applicability in any computing or processing environment. The system may be implemented in hardware, software, or a combination of the two (e.g., using an ASIC (application-specific integrated circuit) or programmable logic. The system may be implemented in one or more computer programs executing on programmable computers that each includes a processor, a storage medium readable by the processor (including volatile and non-volatile memory and/or storage elements), at least one input device, and one or more output devices. Program code may be applied to data entered by a user to generate output information, such as the GUIs noted above.

Each such program may be implemented in a high level procedural or object-oriented programming language to communicate with a computer system. However, the programs can be implemented in assembly or machine language. The language may be a compiled or an interpreted language.

Each computer program may be stored on a storage medium or device (e.g., CD-ROM, hard disk, or magnetic diskette) that is readable by a general or special purpose programmable computer for configuring and operating the computer when the storage medium or device is read by the computer to perform the system. The system may also be implemented, at least in part, as a computer-readable storage medium, configured with a computer program, where, upon execution, instructions in the computer program cause a computer to operate appropriately.

Other embodiments not described herein are also within the scope of the following claims.

What is claimed is:

1. A computer-implemented method for controlling a trading account owned by a securities trader, comprising:
receiving information including a password and data identifying the trading account and the securities trader;
obtaining access to the trading account based on the information; and
performing an action that relates to the trading account without requiring the consent of the securities trader to perform the action.

2. The method of claim 1, wherein the action comprises formulating a securities trade for the securities account.

3. The method of claim 1, wherein the action comprises executing a trade from the securities account.

4. The method of claim 1, wherein the action comprises viewing trades made by the securities trader from the securities account.

5. The method of claim 1, wherein the action comprises reporting trading activity from the trading account to a third party.

6. The method of claim 1, wherein, if the trading account has open positions, the action comprises updating the trading account.

7. The method of claim 6, wherein updating the trading account comprises storing information relating to trading activity that occurred within a predetermined time period.

8. The method of claim 1, wherein the action comprises setting privileges available to the securities trader on the trading account, the privileges defining operations that the trader can perform from the securities account.

9. The method of claim 8, wherein setting comprises modifying existing privileges of the securities trader.

10. The method of claim 8, wherein, if the securities trader has no previously-established privileges, setting comprises establishing privileges for the securities trader.

11. The method of claim 1, wherein the action comprises setting login criteria to the trading account for the securities trader.

12. The method of claim 1, wherein the action comprises setting a buying limit for the securities trader on the trading account.

13. The method of claim 1, wherein the action comprises setting broker commission payment amounts for the securities account.

14. The method of claim 1, wherein the action comprises combining one or more trades made from the securities account into a single trade.

15. The method of claim 1, wherein the action comprises updating information in the trading account.

16. The method of claim 15, wherein the information in the trading account comprises one or more of a user name, a password, a buying limit, a commission fee, an account number, an account type, and connections to servers for market makers.

17. The method of claim 1, wherein the action comprises viewing one or more messages sent from a server to the trading account.

18. The method of claim 1, wherein the action comprises viewing one or more messages sent from the trading account to a server.

19. The method of claim 1, wherein the action comprises viewing performance of a security in the trading account.

20. The method of claim 1, wherein the action comprises viewing a value of the trading account.

21. A machine-readable medium comprising instructions for controlling a trading account owned by a securities trader, the instructions causing a machine to:
receive information including a password and data identifying the trading account and the securities trader;
obtain access to the trading account based on the information; and
perform an action that relates to the trading account without requiring the consent of the securities trader to perform the action.

22. The machine-readable medium of claim 21, wherein the action comprises formulating a securities trade for the securities account.

23. The machine-readable medium of claim 21, wherein the action comprises executing a trade from the securities account.

24. The machine-readable medium of claim 21, wherein the action comprises viewing trades made by the securities trader from the securities account.

25. The machine-readable medium of claim 21, wherein the action comprises reporting trading activity from the trading account to a third party.

26. The machine-readable medium of claim 21, wherein, if the trading account has open positions, the action comprises updating the trading account.

27. The machine-readable medium of claim 26, wherein updating the trading account comprises storing information relating to trading activity that occurred within a predetermined time period.

28. The machine-readable medium of claim 21, wherein the action comprises setting privileges available to the securities trader on the trading account, the privileges defining operations that the trader can perform from the securities account.

29. The machine-readable medium of claim 28, wherein setting comprises modifying existing privileges of the securities trader.

30. The machine-readable medium of claim 28, wherein, if the securities trader has no previously-established privileges, setting comprises establishing privileges for the securities trader.

31. The machine-readable medium of claim 21, wherein the action comprises setting login criteria to the trading account for the securities trader.

32. The machine-readable medium of claim 21, wherein the action comprises setting a buying limit for the securities trader on the trading account.

33. The machine-readable medium of claim 21, wherein the action comprises setting broker commission payment amounts for the securities account.

34. The machine-readable medium of claim 21, wherein the action comprises combining one or more trades made from the securities account into a single trade.

35. The machine-readable medium of claim 21, wherein the action comprises updating information in the trading account.

36. The machine-readable medium of claim 35, wherein the information in the trading account comprises one or more of a user name, a password, a buying limit, a commission fee, an account number, an account type, and connections to servers for market makers.

37. The machine-readable medium of claim 21, wherein the action comprises viewing one or more messages sent from a server to the trading account.

38. The machine-readable medium of claim 21, wherein the action comprises viewing one or more messages sent from the trading account to a server.

39. The machine-readable medium of claim 21, wherein the action comprises viewing performance of a security in the trading account.

40. The machine-readable medium of claim 21, wherein the action comprises viewing a value of the trading account.

41. A computer network comprising:
a first computer for use by a securities trader; and
a second computer for use by an account administrator, the account administrator controlling a trading account owned by the securities trader from the second computer;
wherein, the second computer executes instructions to perform functions comprising:
receiving, from the account administrator, information including a password and data identifying the trading account and the securities trader;
providing the information to an authenticating server to obtain access to the trading account; and
performing an action that relates to the trading account without requiring the consent of the securities trader to perform the action.

42. The computer network of claim 41, wherein the action comprises formulating a securities trade for the securities account.

43. The computer network of claim 41, wherein the action comprises executing a trade from the securities account.

44. The computer network of claim 41, wherein the action comprises viewing trades made by the securities trader from the securities account.

45. The computer network of claim 41, wherein the action comprises reporting trading activity from the trading account to a third party.

46. The computer network of claim 41, wherein, if the trading account has open positions, the action comprises updating the trading account.

47. The computer network of claim 46, wherein updating the trading account comprises storing information relating to trading activity that occurred within a predetermined time period.

48. The computer network of claim 41, wherein the action comprises setting privileges available to the securities trader on the trading account, the privileges defining operations that the trader can perform from the securities account.

49. The computer network of claim 48, wherein setting comprises modifying existing privileges of the securities trader.

50. The computer network of claim 48, wherein, if the securities trader has no previously-established privileges, setting comprises establishing privileges for the securities trader.

51. The computer network of claim 41, wherein the action comprises setting login criteria to the trading account for the securities trader.

52. The computer network of claim 41, wherein the action comprises setting a buying limit for the securities trader on the trading account.

53. The computer network of claim 41, wherein the action comprises setting broker commission payment amounts for the securities account.

54. The computer network of claim 41, wherein the action comprises combining one or more trades made from the securities account into a single trade.

55. The computer network of claim 41, wherein the action comprises updating information in the trading account.

56. The computer network of claim 55, wherein the information in the trading account comprises one or more of a user name, a password, a buying limit, a commission fee, an account number, an account type, and connections to servers for market makers.

57. The computer network of claim 41, wherein the action comprises viewing one or more messages sent from a server to the trading account.

58. The computer network of claim 41, wherein the action comprises viewing one or more messages sent from the trading account to a server.

59. The computer network of claim 41, wherein the action comprises viewing performance of a security in the trading account.

60. The computer network of claim 41, wherein the action comprises viewing a value of the trading account.
